(19) United States
(12) Patent Application Publication
(10) Pub. No.: US 2014/0249913 A1
(43) Pub. Date: Sep. 4, 2014

(54) ADVERTISEMENT PRESENTATION SYSTEM, ADVERTISEMENT PRESENTATION DEVICE, AND ADVERTISEMENT PROVISION DEVICE

(71) Applicant: Masato Endo, Nagoya-shi (JP)

(72) Inventor: Masato Endo, Nagoya-shi (JP)

(73) Assignee: TOYOTA JIDOSHA KABUSHIKI KAISHA, Toyota-shi, Aichi (JP)

(21) Appl. No.: 14/352,415

(22) PCT Filed: Oct. 20, 2011
(86) PCT No.: PCT/JP2011/074104

§ 371 Date: Apr. 17, 2014

(51) Int. Cl. G06Q 30/02

(52) U.S. Cl. CPC G06Q 30/0266; G06Q 30/0246
USPC 705/14.45

(57) ABSTRACT

An information management center transmits advertisement information to a vehicle. The vehicle displays a predetermined advertisement on a body display part based on the transmitted advertisement information. After a predetermined time has passed since the display of the advertisement by the body display part ended, the information management center acquires the results information about change of the sales results of an advertised good which is an object of a predetermined advertisement from the store existing within a predetermined distance from a location of the body display part through a network. The information management center returns remuneration to a user of the vehicle which permitted use of the body display part, when a sales volume, for example, is increasing based on the acquired results information.

### TECHNICAL FIELD

The present invention relates to an advertisement presentation system, an advertisement presentation device and an advertisement provision device, which present a predetermined advertisement based on predetermined advertisement information.

### BACKGROUND ART

Conventionally, for example, a visit confirmation information processing system as shown in the following patent document 1 (PTL 1) is known. This conventional visit confirmation information processing system is configured so as to afford a visit confirmation by generation a log associated with a browsing log at a website and an actual visit log at a store based on these logs.

Moreover, conventionally, for example, a navigation managerial system as shown in the following patent document 2 (PTL 2) is also known. This conventional navigation managerial system is configured so as to count up success information which reports that a personal digital assistant device has succeeded in navigation to a store into a success count and compute the billing amount which should be charged in exchange for the success of navigation based on the success count. Thereby, those who receive a navigation service are able to pay the provider of the navigation service a counter value according to a success of guidance.

Moreover, conventionally, for example, a delivery system as shown in the following patent document 3 (PTL 3) is also known. This delivery system is equipped with a word-of-mouth information management server which manages word-of-mouth information associated with document contents which an information provider described about an advertiser's store, a secondary affiliate ID and link information for accessing an advertiser server, and location information which shows the location of the advertiser's store, and this word-of-mouth information management server is configured so as to register new word-of-mouth information only in the case where it is judged that the new word-of-mouth information can be registered when the new word-of-mouth information is to be registered. Thereby, how much word-of-mouth information contributes to an advertisement can be figured out clearly and the credibility of word-of-mouth information can be improved.

Moreover, conventionally, for example, a program and computer system as shown in the following patent document 4 (PTL 4) are also known. These conventional program and computer system are configured so that a user can be guided to a store selling an item which others' avatar is wearing when the user clicks the others' avatar on a screen and an affiliate (remuneration) for triggering a merchandise sale can be given to the others' avatar when the item is purchased at this store.

Furthermore, conventionally, for example, an advertisement display method for vehicles, an advertisement display system, and an advertisement display vehicle as shown in the following patent document 5 (PTL 5) are also known. In this conventional advertisement display system, it is configured so that an enterprising body can create an advertisement in response to a request from an advertisement client and thus created advertisement can be computerized and transmitted to vehicles from a radio service firm as advertisement data. Then, in vehicles, it is configured so that an advertisement display device installed in the vehicles can receive the advertisement data, display an advertisement based on advertisement data according to its running area among the received advertisement data, and advertise to the person outside the vehicle.

### CITATION LIST

### Patent Literature

[PTL 1] Japanese Patent Application Laid-Open (kokai) No. 2008-117159
[PTL 2] Japanese Patent Application Laid-Open (kokai) No. 2006-330943
[PTL 3] Japanese Patent Application Laid-Open (kokai) No. 2008-176570
[PTL 4] Japanese Patent Application Laid-Open (kokai) No. 2008-217142
[PTL 5] Japanese Patent Application Laid-Open (kokai) No. 2002-63482

### SUMMARY OF INVENTION

In each above-mentioned conventional device, Since there is a relation with which a provider of information and a user who uses the provided information can be specified, it becomes possible to pay the provider of information remuneration (affiliate) easily with the user's action, for example. However, especially when an advertisement is displayed to general public, it is quite difficult to specify a person who actually viewed this displayed advertisement and purchased an advertised good, and therefore it is impossible to appropriately evaluate advertising effectiveness due to the display (delivery) of the advertisement (information), and as a result it is difficult to pay suitable remuneration (affiliate) to the person who provided the display medium for displaying the advertisement, for example.

Moreover, with respect to an advertising effectiveness based on displayed contents of an advertisement, the conventional advertisement display system shown in the above-mentioned patent document 5 displays an advertisement based on advertisement data according to its running area to advertise a person outside a vehicle, i.e. a viewer who can view an advertisement (information) through the advertisement display device. Generally, advertising effectiveness (what is called, a propaganda effect) has a tendency that its effect goes up and down depending on the height of concern and the existence of interest of a person which looks at this advertisement or information. In this connection, as for the above-mentioned conventional advertisement display system which stereotypically displays an advertisement on an advertisement display device according to its running area, there is a possibility that the displayed advertisement may not be always information with a viewer's concern or interest and it may not be said that sufficient advertising effectiveness (propaganda effect) has been attained.

Moreover, with respect to an advertising effectiveness based on a displaying embodiment of an advertisement, the conventional advertisement display system shown in the above-mentioned patent document 5 is intended for specific vehicles and each of the specific vehicles separately displays an advertisement using its advertisement display device based on advertisement data. For this reason, it will be hard to say that sufficient advertising effectiveness has been attained since a viewer (audience) who looks at an advertisement is restricted, in other words, the display density of an advertisement is low. In this connection, in recent years, for the purpose of raising the display density of an advertisement and raising advertising effectiveness, i.e., a propaganda effect, a technique of presenting advertisements of the same business operator in a concentrated (occupied) manner at a specific area or specific space may be adopted. It is said that advertising effectiveness (propaganda effect) can be heightened since the opportunity for a viewer (audience) to look at an advertisement can be increased by thus intensively (dominantly) presenting advertisements. However, when such a technique is applied to vehicles, it becomes difficult for a specific vehicle to intensively (dominantly) present advertisements of the same business operator in the same area since vehicles move.

The present invention has been conceived in order to solve the above-mentioned subject and has one of its purposes in providing an advertisement presentation system, an advertisement presentation device, and an advertisement provision device which appropriately evaluate an advertising effectiveness due to an advertisement display and pay suitable remuneration.

In order to attain the above-mentioned purpose, an aspect of the present invention is in that an advertisement presentation system comprising an advertisement presentation means to acquire advertisement information expressing an advertisement and to display and present a predetermined advertisement to general public based on this acquired advertisement information, and an advertisement information provision means to provide said advertisement information to this advertisement presentation means, comprises: a results information acquisition means to acquire results information about a change of sales results of an advertised good which is an object of said predetermined advertisement, which changes due to presentation of said predetermined advertisement by said advertisement presentation means, and a remuneration determination means to determine remuneration to be paid to presentation of said predetermined advertisement by said advertisement presentation means, based on said acquired results information. In this case, for example, said results information acquisition means can be connected with a network to acquire said results information from the store which sells said advertised good through the network. Moreover, in this case, for example, said remuneration determination means can determine said remuneration with a time limit or use restriction.

In accordance with these, when a predetermined advertisement for advertising an advertised good is presented to general public (viewers) by an advertisement presentation means based on the advertisement information provided from an advertisement provision means, results information about a change of the sales results of the advertised good, which changes due to these presentation can be acquired and remuneration to be paid to advertisement presentation can be determined based on this results information. Namely, since a change of the sales results of an advertised good expressed using results information correlates with a predetermined advertisement being presented by an advertisement presentation means, the advertising effectiveness accompanying presenting an advertisement to general public can be evaluated appropriately and remuneration can be determined based on results information. Moreover, since results information can be acquired through a network from a store which sells an advertised good, for example, even when a person (viewer) who looked at a predetermined advertisement displayed by the advertisement presentation means purchases an advertised good using a store established on the Internet, etc., exact results information can be acquired and suitable remuneration to advertisement presentation can be determined. Moreover, for example, when remuneration is paid as, what is called, a point, use of this point can be stimulated by setting up a time limit and use restriction to the determined remuneration.

In this case, the advertisement presentation system may comprise a location information acquisition means to acquire location information expressing location of said advertisement presentation means, and said results information acquisition means may acquire said results information about a change of the sales results of said advertised good within a predetermined distance from the location of said advertisement presentation means expressed by said acquired location information. Then, in this case, said results information acquisition means may acquire said results information about a change of the sales results of said advertised good, for example, within a predetermined time period after said advertisement presentation means ends presentation of said predetermined advertisement, or after a predetermined time period has passed since said advertisement presentation means ends the presentation. Moreover, in these cases, said remuneration determination means can determine remuneration according to an increase relevant to a sales volume of said advertised good, for example, based on said acquired results information, when the increase relevant to the sales volume of said advertised good among changes of the sales results of said advertised good is larger than a predetermined increase set up beforehand.

In accordance with these, results information about a change of sales results of an advertised good within a predetermined distance from the location of an advertisement presentation means which presents a predetermined advertisement can be acquired and, more particularly, results information about a change of the sales results of an advertised good, within a predetermined time period after the advertisement presentation means ends presentation of the predetermined advertisement or after a predetermined time period has passed since the advertisement presentation means ends the presentation. Thereby, a correlation between a predetermined advertisement being presented by an advertisement presentation means and a change of the sales results of an advertised good expressed using results information can be evaluated with higher precision and based on this highly precise results information, advertising effectiveness accompanying displaying an advertisement can be evaluated more appropriately and then, for example, remuneration can be determined according to increase relevant to a sales volume of the advertised good.

Moreover, in these cases, said advertisement presentation means may be configured so as to afford a short-distance wireless communication with at least an information terminal device which exists in surroundings, and said results information acquisition means may comprise; a communication results information acquisition means to acquire communication results information about a track record of a short-distance wireless communication between said advertisement presentation means and said information terminal device, and an advertised good purchase information acquisition means to acquire advertised good purchase information about purchase of said advertised good by a user of said information terminal device related with said acquired communication results information, and said results information acquisition means may acquire said results information about a change of the sales results of said advertised good based on said acquired advertised good purchase information. In this case, for example, said information terminal device may acquire said advertisement information from said advertisement presentation means through said short-distance wireless communication, and may present said predetermined advertisement based on said acquired advertisement information to said user. Moreover, in these cases, acquisition of said communication results information by said communication results information acquisition means may be permitted or forbidden by the user of said information terminal device, for example. Moreover, in these cases, said remuneration determination means may determine the predetermined remuneration to be paid to the user of said information terminal device, at least when a track record of a short-distance wireless communication between said advertisement presentation means and said information terminal device exists, for example, based on said acquired communication results information. Furthermore, in this case, the remuneration information which expresses said predetermined remuneration determined by said remuneration determination means may be transmitted to said information terminal device, for example.

In accordance with these, results information based on a fact that a user of an information terminal device with a track record of a short-distance wireless communication with an advertisement presentation means actually purchased an advertised good can be acquired. Thereby, a correlation with a fact that a predetermined advertisement is presented by an advertisement presentation means and a change of the sales results of an advertised good expressed using results information can be evaluated with quite high precision and, based on this highly precise results information, advertising effectiveness accompanying displaying an advertisement can be evaluated more appropriately. Moreover, since a user of an information terminal device can grant permission or forbid to acquire communication results information, for example, acquisition of the communication results information on a short-distance wireless communication can be permitted to obtain remuneration, and acquisition of the communication results information on a short-distance wireless communication can be forbidden to secure privacy.

Moreover, another aspect of the present invention is also in that, in an advertisement presentation device comprising a display part which displays an advertisement and a control part which controls the display of the advertisement by this display part, said control part acquires advertisement information expressing an advertisement acquired from the outside, displays and presents a predetermined advertisement to general public based on this acquired advertisement information, and acquires remuneration to be paid to presentation of said predetermined advertisement, according to a change of sales results of an advertised good which is an object of said predetermined advertisement. In this case, said control part can acquire location information expressing location of said display part at least, and can remuneration to be paid to presentation of said predetermined advertisement, according to a change of the sales results of said advertised good within a predetermined distance from the location of said display part expressed by said acquired location information. Moreover, in these cases, said control part can deliver said advertisement information acquired from said outside to an information terminal device which exists in the surroundings of said display part, for example, through a short-distance wireless communication with said information terminal device, at least. Furthermore, in these cases, said display part may be disposed on an outside surface of an outer panel of a vehicle and may display an image outward from said vehicle, for example.

In accordance with these, by presenting a predetermined advertisement to general public based on advertisement information acquired from the outside, remuneration to be paid to presentation of a predetermined advertisement can be acquired according to a change of sales results of an advertised good corresponding to this presented predetermined advertisement. Thereby, advertising effectiveness accompanying presenting an advertisement can be evaluated appropriately, and remuneration appropriately determined based on this evaluation can be acquired.

Moreover, another aspect of the present invention is also in that an advertisement provision device which provides the outside with advertisement information which expresses an advertisement, comprises: a results information acquisition means to acquire results information about a change of the sales results of an advertised good which is an object of an predetermined advertisement, which is changed by providing the outside with said advertisement information which expresses said predetermined advertisement, and a remuneration determination means to determine remuneration to be paid to said outside, based on said acquired results information. In this case, said advertisement presentation device may comprise a location information acquisition means to acquire location information expressing location of said outside to which advertisement information expressing said predetermined advertisement is provided, and said results information acquisition means may acquire said results information about a change of the sales results of said advertised good within a predetermined distance from the location of said outside expressed by said acquired location information. In this case, said results information acquisition means may acquire said results information about a change of the sales results of said advertised good, within a predetermined time period after said advertisement information which expresses said predetermined advertisement is provided to said outside, or after a predetermined time period has passed since said advertisement information is provided to said outside, for example.

Moreover, in these cases, said results information acquisition means may comprise; a communication results information acquisition means to acquire communication results information about a track record of a short-distance wireless communication between said outside and an information terminal device which exists in surroundings of said outside to which said advertisement information expressing said predetermined advertisement is provided, and an advertised good purchase information acquisition means to acquire advertised good purchase information about purchase of said advertised good by a user of said information terminal device related with said acquired communication results information, and may acquire said results information about a change of the sales results of said advertised good based on said acquired advertised good purchase information. Then, in this case, acquisition of said communication results information by said communication results information acquisition means may be permitted or forbidden by the user of said information terminal device, for example.

In accordance with these, when advertisement information expressing a predetermined advertisement is provided to the outside, results information about a change of the sales results of an advertised good, which is changed by this providing may be acquired, and remuneration to be paid to said outside may be determined based on this results information. Namely, since a change of sales results of an advertised good expressed using results information correlates with a predetermined advertisement being presented by an advertisement presentation means, advertising effectiveness accompanying presenting an advertisement to general public can be evaluated appropriately and remuneration can be determined, based on results information.

Moreover, results information about a change of sales results of an advertised good within a predetermined distance from the location of the outside to which advertisement information expressing a predetermined advertisement is provided can be acquired and, more particularly, results information about a change of sales results of an advertised good, within a predetermined time period after advertisement information which expresses a predetermined advertisement is provided to the outside, or after a predetermined time period has passed since the advertisement information is provided to the outside. Thereby, a correlation between advertisement information expressing a predetermined advertisement being provided to the outside and a change of the sales results of an advertised good expressed using results information can be evaluated with higher precision and based on this highly precise results information, advertising effectiveness accompanying providing advertisement information can be evaluated more appropriately.

Furthermore, results information based on a fact that a user of an information terminal device with a track record of a short-distance wireless communication with the outside to which advertisement information expressing a predetermined advertisement actually purchased an advertised good can be acquired. Thereby, a correlation between advertisement information expressing a predetermined advertisement being provided to the outside and a change of sales results of an advertised good expressed using results information can be evaluated with quite high precision and based on this highly precise results information, advertising effectiveness accompanying providing advertisement information can be evaluated more appropriately

Here, with respect to contents and embodiment of an advertisement which is displayed through a vehicle, for example, in order to make it possible to deliver at least advertisement information in which a viewer is interested, it is desirable to adopt a vehicle information delivery device which delivers information through a vehicle to a viewer who exists in the surroundings of said vehicle and views a variety of information, comprising an information acquisition means to acquire information about a user of said vehicle and information about a viewer who exists in the surroundings of said vehicle, and an information delivery means to acquire predetermined information based on the information about the user of said vehicle and the information about said viewer thus acquired, and to delivery said predetermined information thus acquired through said vehicle. In this case, it is desirable that the information about the user of said vehicle and the information about said viewer acquired by said information acquisition means comprise at least preference information including preference of each user of said vehicle and said viewer and relationship information which expresses a relationship between the user of said vehicle and said viewer.

In accordance with this, the information delivery means can acquire the predetermined information (including the advertisement information) based on information about the user of the vehicle and information about the viewer, more specifically, the preference information and/or the relationship information of the user of the vehicle and the viewer, and deliver the predetermined information to the viewer. Therefore, it can automatically deliver, for example, information which is consistent with the preference of the user of the vehicle and the viewer according to the preference information of the user of the vehicle and the viewer's preference information, and/or information which is be compatible with the relationship of the user of the vehicle and the viewer according to the relationship information of the user of the vehicle and the viewer, in other words, information that the user of the vehicle wants to provide to the viewer and the viewer is interested in. In addition, the “delivery” in this case includes delivery of information by direct communication and secure delivery of information, for example, through a center (server).

In this case, based on the information about the user of said vehicle and the information about said viewer thus acquired, said information delivery means can acquire a message from the user of said vehicle to said viewer as said predetermined information and deliver it through said vehicle when the user of said vehicle and said viewer have a specific relation.

In accordance with this, when there is a specific relation (for example, relations such as a family, friends, friends in a community using a social networking service (SNS), fellow students, fellow citizens, people in the same business, etc.) between a user of a vehicle and a viewer, for example, the user of the vehicle can deliver a message (including advertisement information) to the viewer without any separate operation. Therefore, information (message) that the user of the vehicle wants to provide to the viewer and the viewer is interested in can be delivered automatically.

Moreover, in these cases, when said a viewer is on a vehicle other than said vehicle and the user of said vehicle and said viewer on said another vehicle have a predetermined relation, said information delivery means can further acquire predetermined information linked to said predetermined information to be delivered to said viewer on said another vehicle through said vehicle on which said user is and deliver said linked predetermined information thus acquired through said another vehicle on which said viewer is.

In accordance with this, when a user of a vehicle and a viewer on another vehicle is in a predetermined relation, for example, a relation in which their destination is the same or close to each other or their traveling direction is the same or close to each other, the user of the vehicle and the viewer on the another vehicle can move while touring (running side by side). And in this case, predetermined information linked to predetermined information (for example, an image and/or a picture) to be delivered to the viewer on the another vehicle through the vehicle can be delivered to the user of the vehicle through the another vehicle. Thereby, information (including advertisement information) which raises a sense of togetherness can be delivered to each other between the vehicle and another vehicle which are touring together.

Moreover, in these cases, said information delivery means can acquire advertisement information expressing a predetermined advertisement as said predetermined information based on said acquired information about said viewer, and can deliver it through said vehicle.

In accordance with this, the information delivery means can acquire at least advertisement information according to the preference of the viewer (advertisement information in which the viewer is interested), as the predetermined information, based on the information about the user of the vehicle and the information about the viewer, more specifically, the preference information and/or relationship information, and can deliver it to the viewer through the vehicle. Therefore, for example, according to the preference information of the user of the vehicle and the preference information of the viewer, advertisement information which is consistent with the preference of the user of the vehicle and the viewer, in other words, information that the user of the vehicle wants to provide to the viewer and the viewer is interested in, can be delivered automatically.

Moreover, in these cases, it is desirable that said predetermined information delivered through said vehicle may be displayed on a display part which is disposed in said vehicle and can be visually recognized by said viewer outside said vehicle, for example. In this case, said display part may be disposed on an outside surface of an outer panel of said vehicle and may display an image outward from said vehicle, for example. In accordance with these, since information can be displayed with the whole vehicle body to the viewer outside the vehicle, quite good visibility can be secured. Alternatively, in these cases, it is desirable that said predetermined information delivered through said vehicle may be displayed on a display device which can be viewed by only a limited viewer, for example. In this case, said display device may communicate with said vehicle, and may acquire and display said delivered predetermined information, for example. In accordance with these, since information can be displayed only to the limited viewer, information for which privacy and/or security need to be secured can be delivered (displayed) to the appropriately limited (specific) viewer, for example.

Moreover, another aspect of the present invention is also in that a vehicle information delivery system which delivers information through a vehicle to a viewer who exists in the surroundings of said vehicle and views a variety of information comprises: a proximity situation acquisition means to acquire a situation where said vehicle is close to a mobile information terminal device which said viewer possesses or another vehicle other than said vehicle, on which said viewer is, a viewer information acquisition means to acquire information about said viewer from said mobile information terminal device or said another vehicle in the proximity of said vehicle, and an information delivery means to acquire advertisement information expressing a predetermined advertisement and to deliver it through said vehicle, based on said acquired information about said viewer. In this case, it is desirable that the information about said viewer acquired by said viewer information acquisition means is at least preference information including said viewer's preference.

In accordance with these, based on only a fact that the a situation where the vehicle and the mobile information terminal device, which the viewer possesses, or the another vehicle, on which the viewer is, are close to each other (or a situation where they pass each other), advertisement information according to the viewer's preference can be delivered through the vehicle, for example. Thereby, information about the viewer can be managed in an integrated fashion and the viewer's privacy can be protected (secured) appropriately.

In addition, also in this case, it is desirable that said advertisement information delivered through said vehicle is displayed on a display part which is disposed on said vehicle and can be visually recognized by said viewer outside said vehicle, for example. In this case, said display part may be disposed on an outside surface of an outer panel of said vehicle and may display an image outward from said vehicle, for example. In accordance with these, since information can be displayed with the whole vehicle body to the viewer outside the vehicle, quite good visibility can be secured. Alternatively, in these cases, it is desirable that said predetermined information delivered through said vehicle may be displayed on a display device which can be viewed by only a limited viewer, for example. In this case, said display device may communicate with said vehicle, and may acquire and display said delivered predetermined information, for example. In accordance with these, since an advertisement can be displayed only to the limited viewer, information for which privacy and/or security need to be secured can be delivered (displayed) to the appropriately limited (specific) viewer, for example.

Moreover, with respect to contents and embodiment of an advertisement which is displayed through a vehicle, for example, in order to make it possible to present an advertisement of a specific business operator in a concentrated manner within a specific area using a vehicle, it is desirable to adopt a vehicular advertisement presentation system to display and present an advertisement using a vehicle, which comprises a vehicle information acquisition means having a display part to display an advertising image outward from a vehicle to acquire vehicle information about plural vehicles which can exist in a specific domain, and an advertisement information transmitting means to transmit advertisement information about an advertisement displayed by said display part to said plural vehicles, wherein said advertisement information to be transmitted includes information about a display embodiment in which the advertising images are displayed in conjunction with one another among said respective display parts which said plural vehicles have when said plural vehicles exist within said specific domain.

In accordance with this, the advertisement information transmitting means can transmit advertisement information to the plural vehicles which can exist in the specific domain based on the vehicle information (for example, current location information of vehicles, etc.) acquired by the vehicle information acquisition means. And when plural (two or more) vehicles which have acquired the same advertisement information exist in the specific domain, each display part of the plural vehicles can display an advertising image outward from the vehicle in accordance with a display embodiment in which the respective display parts display the advertising image in conjunction with one another, based on the same advertisement information. Thereby, an advertising density can be effectively heightened by the plural vehicles in the specific domain, more specifically the display parts which the plural vehicles have, intensively (dominantly) displaying, for example, an advertising image of a specific business operator and, as a result, the opportunity for a viewer (audience) to look at the advertisement can be increased to dramatically heighten the advertising effectiveness (propaganda effect).

In this case, the display embodiment, in which the respective display parts display said advertising image in conjunction with one another, includes a display embodiment in which said respective display parts which said plural vehicles have display the advertising image synchronously with one another.

In accordance with this, the display part installed in each of the plural vehicles may concurrently display the advertising images synchronously with one another, for example, by synchronizing (uniforming) the advertising images to be displayed and/or synchronizing (uniforming) the timing for displaying the advertising images, etc. By thus displaying an advertising image synchronously with one another, a strong impression can be given to an audience outside the vehicle and, as a result, advertising effectiveness (propaganda effect) can be dramatically heightened.

Moreover, in these cases, said advertisement information may be the information about the advertisements by the same business operator or the business operators who has a specific relation, for example. In accordance with this, advertisements of the same business operator can be presented intensively (dominantly) in a specific domain and an advertising density can be effectively heightened to dramatically improve advertising effectiveness (propaganda effect). Moreover, advertisements of business operators in a specific relation can be presented intensively (dominantly) in a specific domain and in this case, for example, advertising effectiveness (propaganda effect) of collaborated goods, etc. can be dramatically improved.

Moreover, in these cases, said plural vehicles may communicate mutually when they display an advertising image on said respective display parts in conjunction with one another based on said advertisement information, for example. In accordance with this, when each display part displays an advertising image in accordance with a predetermined display embodiment, specifically when displaying an advertising image in conjunction and/or synchronously with one another, plural vehicles can display the advertising image more appropriately and correctly in conjunction (and/or synchronously) with one another by communicating with one another. Therefore, advertising effectiveness (propaganda effect) can be dramatically heightened by displaying an advertising image in conjunction (and/or synchronously) with one another thus appropriately and correctly.

Moreover, in these cases, for example, said advertisement information transmitting means may transmit said advertisement information to the plural vehicles which exist in said specific domain. In accordance with this, since advertisement information can be transmitted only to the plural vehicles which already exist in a specific domain, it becomes possible to simplify the configuration of an advertisement information transmitting means while the load for processing the transmission by the advertisement information transmitting means can be reduced.

Moreover, in these cases, for example, said advertisement information transmitting means may transmit said advertisement information to one vehicle which exist in said specific domain, and said one vehicle can transmit said advertisement information which was received and was acquired from said advertisement information transmitting means to other plural vehicles which exist in said specific domain. In accordance with this, since advertisement information can be transmitted to one vehicle which exist in a specific domain and thereby the one vehicle can transmit the same advertisement information to other plural vehicles which exist in the specific domain, it becomes possible to simplify the configuration of the advertisement information transmitting means while the load for processing the transmission by the advertisement information transmitting means can be reduced.

Furthermore, in these cases, for example, said display part may be disposed on an outside surface of an outer panel of said vehicles and may display an advertising image outward from said vehicles. In accordance with this, since the advertising image can be displayed with the whole vehicle body, a strong impression can be given to audience and, as a result, advertising effectiveness (propaganda effect) can be dramatically improved.

### BRIEF DESCRIPTION OF DRAWINGS

FIG. 1 is a schematic block diagram showing an advertisement presentation system according to the first embodiment of the present invention, which comprises a vehicle, an information management center, and a store.

FIG. 2 is a block diagram schematically showing the configuration of a vehicle common to respective embodiments of the present invention.

FIG. 3 is a schematic view for explaining a state where the body display part in FIG. 2 is disposed on an outside surface of an outer panel of the vehicle.

FIG. 4 is a block diagram schematically showing the configuration of an information management center common to respective embodiments of the present invention.

FIG. 5 is a block diagram schematically showing the configuration of a store common to respective embodiments of the present invention.

FIG. 6 is a flow chart showing an advertisement presentation program according to the first embodiment of the present invention, which the information management server in the information management center in FIG. 4 executes.

FIG. 7 is a schematic block diagram showing an advertisement presentation system according to the second embodiment of the present invention, which comprises a vehicle, an information management center, a store, and an information terminal device.

FIG. 8 is a block diagram schematically showing the configuration of the configuration of the information terminal device in FIG. 7 according to the second embodiment of the present invention.

FIG. 9 is a time chart of respective processings in the vehicle, information management center, and information terminal device (store) according to the second embodiment of the present invention.

FIG. 10 is a flow chart showing an advertisement delivery program according to a modification of the present invention, which an information management server in an information management center executes.

FIG. 11 is a schematic view for explaining a display embodiment of a message as information displayed on a body display part of a vehicle by execution of the information delivery program in FIG. 10 when a driver and a viewer are in a specific relation.

FIG. 12 is a schematic view for explaining a display embodiment of an image as information displayed in conjunction with one another on each body display part of respective vehicles by execution of the information delivery program in FIG. 10 when they are traveling (touring) together.

FIG. 13 is a flow chart showing an advertisement delivery routine corresponding to a preference in the information delivery program shown in FIG. 10 according to a modification of the present invention.

FIG. 14 is a flow chart showing an advertisement presentation program according to a modification of the present invention, which an electronic control unit in a vehicle and an information management server in an information management center executes in cooperation with each other.

FIG. 15 is a schematic view for explaining a cooperative display according to a modification of the present invention, among display embodiments of an advertisement displayed on each body display part of respective vehicles by execution of the advertisement presentation program in FIG. 14.

FIG. 16 is a schematic view for explaining a synchronous display according to a modification of the present invention, among display embodiments of an advertisement is displayed on each body display part of respective vehicles by execution of the advertisement presentation program in FIG. 14.

### DESCRIPTION OF EMBODIMENTS

### a. First Embodiment

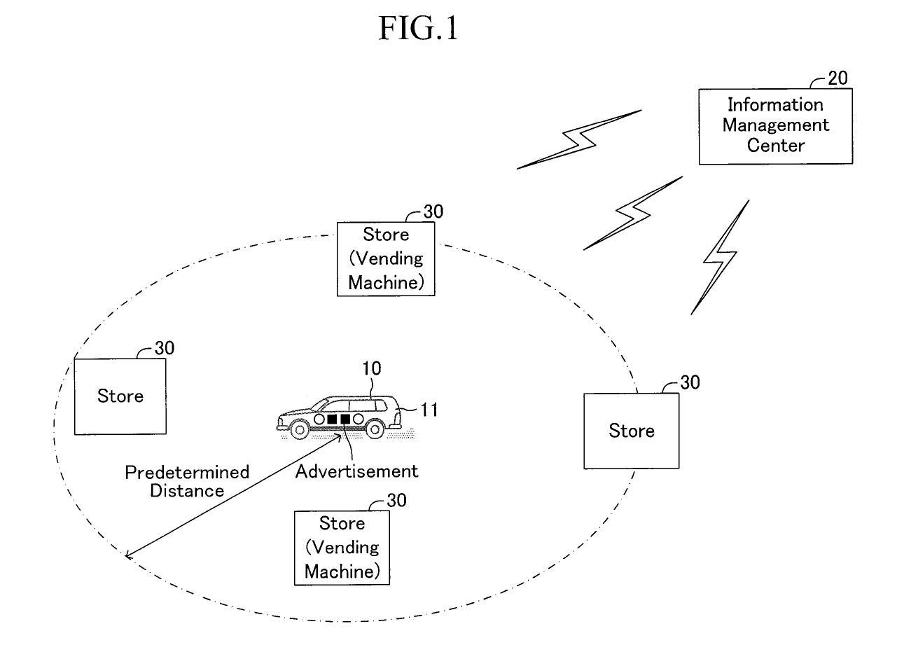

An advertisement presentation system comprising an advertisement presentation device and an advertisement information provision device according to an embodiment of the present invention will be explained hereafter using a drawing. FIG. 1 is a schematic block diagram schematically showing an advertisement presentation system according to the first embodiment of the present invention. As shown in FIG. 1, this advertisement presentation system according to the first embodiment comprises a vehicle 10 (advertisement presentation device), an information management center 20 (advertisement provision device), and a store 30 that exists within a predetermined distance from the vehicle 10 as a center. And in this advertisement presentation system, the vehicle 10 displays an advertisement based on advertisement information expressing an advertisement transmitted from the information management center 20, remuneration (reward point) is paid to a user of the vehicle 10, i.e. an advertisement deliverer, when a significant change arises in sales results of an advertised good which is an object of the advertisement displayed with the vehicle 10 at the store (or vending machine) 30 which exists within the predetermined distance from the vehicle 10. Thus, by configuring this advertisement presentation system, suitable remuneration according to the sales results of the advertised goods, namely based on the evaluation of the advertising effectiveness associated with the display of the advertisement can be paid to the user who offered the vehicle 10 as an advertisement display medium, i.e. an advertisement deliverer.

The vehicle 10 may be a display medium of an advertisement and may comprise a body display part 11 as a display part which displays and presents an advertisement comprising an image (picture) and/or a message, etc. outward from the vehicle 10 to general public. The body display part 11 may comprise a well-known light-emitting type panel (for example, a plasma display panel, an organic electroluminescence display panel, etc.) and/or a transmissive type display panel (for example, a liquid-crystal-display panel with a back light, etc.), as well as a well-known drive circuit (not shown) for operating these display panels.

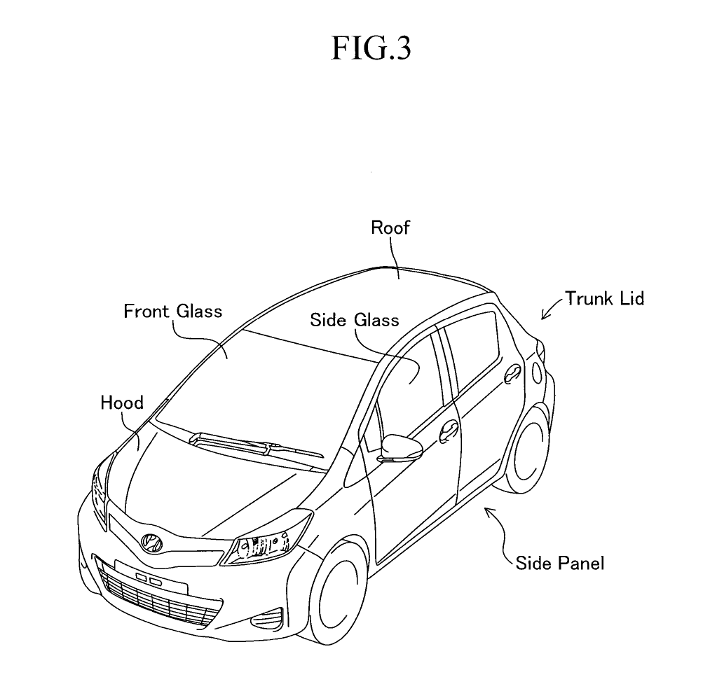

Here, the body display part 11 displays an image (picture) outward from the vehicle 10. For this reason, the body display part 11 in the present embodiment is disposed on an outside surface of an outer panel of the vehicle 10, for example, by attaching the above-mentioned light-emitting type display panel and/or transmissive type display panel thereon. Specifically, as schematically shown in FIG. 3, on any of a hood (bonnet), left and right side panels (fenders, door panels, pillars, etc.), a roof and a trunk lid (rear gate) or, when required transparency can be secured, a front, rear and side glasses, which form the outer shape of the vehicle 10, the body display part 11 formed as a sheet is stuck and a transparent protection layer (for example, resin materials, such as polycarbonate) is disposed on the outside surface of this body display part 11 thus stuck. Thereby, thus stuck body display part 11 can display (play) an advertisement comprising various images (pictures) and/or messages, etc. outward from the vehicle 10.

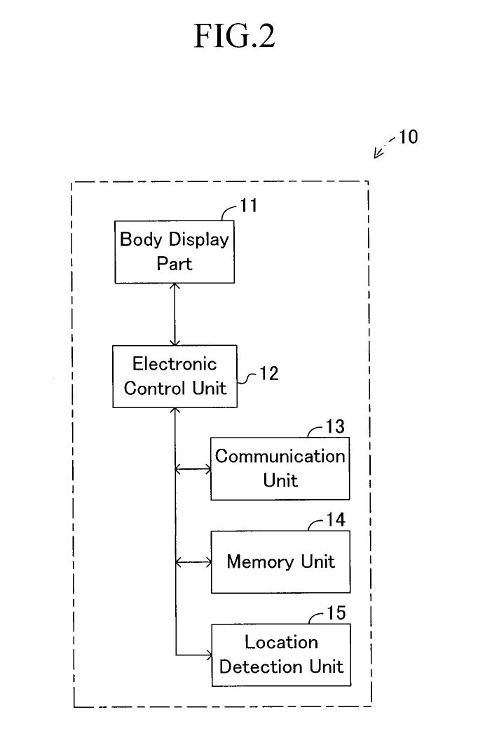

Moreover, as shown in FIG. 2, the vehicle 10 comprises an electronic control unit 12, a communication unit 13, a memory unit 14, and a location detection unit 15.

The electronic control unit 12 is a microcomputer which comprises CPU, ROM, RAM, etc. as main component parts, and comprehensively controls the operation of the vehicle 10 (more particularly, the body display part 11) by executing various programs. For this reason, to the electronic control unit 12, the communication unit 13, the memory unit 14, and the location detection unit 15 are electrically connected so that they can communicate respectively.

The communication unit 13 enables various communications between the information management center 20, etc. and the exteriors. In addition, the correspondence procedure itself by the communication unit 13 does not relate directly to the present invention, and well-known correspondence procedures (for example, Bluetooth (registered trademark) and Wi-Fi (registered trademark), short-distance and middle-distance communications using NFC (Near Field Communication), a mobile phone line network including communication base stations and a network communication using the Internet circuit network, etc.) may be employed. Thereby, as will be mentioned later, the electronic control unit 12 can communicate with the information management center 20 using the communication unit 13, and can transmit and receive a variety of information and data including advertisement information expressing a predetermined advertisement.

The memory unit 14 contains a storage medium (such as a hard disk and semiconductor memory) and a drive device for the storage medium, and memorizes various programs and various data updatably. Here, as the various data memorized by the memory unit 14, for example, an information table with information such as an image (picture) data contained in advertisement information transmitted (delivered) from the information management center 20 so that it may be displayed on the body display part 11 and/or luminance about display using the body display part 11, as will be mentioned later, written therein.

The location detection unit 15 detects current location of the vehicle 10. For this reason, for example, the location detection unit 15 acquires GPS (Global Positioning System) signals respectively detected from three or more GPS satellites and detects current location of the vehicle 10 (body display part 11) based on these GPS signals, or collaborates with the communication unit 13 to acquire a signal transmitted from a communication base station for mobile phone line networks and detects current location of the vehicle 10 (body display part 11) based on this transmitted signal, or detects current location of the vehicle 10 (body display part 11) based on both the GPS signals from the GPS satellites and the transmitted signal from the communication base station. And the location detection unit 15 is configured so as to output current location information expressing the detected current location to the electronic control unit 12. In addition, the location detection unit 15 is configured so as to be able to detect the direction of movement of the vehicle 10 by its current location detection function and also output direction-of-movement information expressing the detected direction of movement to the electronic control unit 12.

The information management center 20 in the present embodiment manages advertisement information provided by a business operator (client) who wishes an advertisement display, and transmits (delivers) the managed advertisement information according to current location of the vehicle 10 or a demand. Moreover, the information management centers 20 judges whether a significant change has arisen in sales results in the store 30 which sells an advertised good by displaying an advertisement through the vehicle 10 (more particularly, the body display part 11), and performs a reward processing in which suitable remuneration (reward point) is determined and paid (given back) to a user who permitted use of the body display part 11 of the vehicle 10 as an advertisement display medium (namely, an advertisement deliverer) when the change has arisen. Therefore, the information management center 20 in the present embodiment comprises a results information acquisition means, a remuneration determination means, and a location information acquisition means.

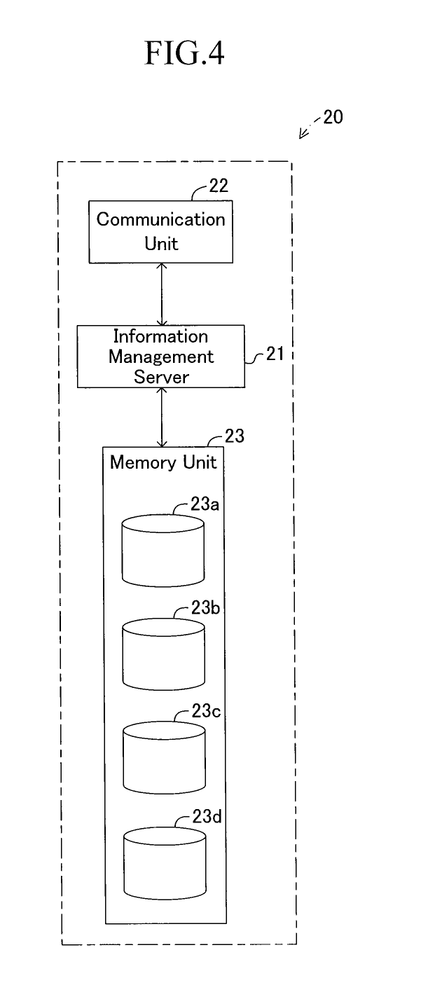

For this reason, the information management center 20 comprises the information management server 21, the communication unit 22, and the memory unit 23, as shown in FIG. 4. The information management server 21 is a microcomputer which comprises CPU, ROM, RAM, etc. as main component parts, and comprehensively controls the information management center 20 by executing various programs including the below-mentioned program. For this reason, to the information management server 21, the communication unit 22 and the memory unit 23 are electrically connected respectively so that communication is possible.

The communication unit 22 enables various communications between the vehicle 10 and the stores 30. In addition, the correspondence procedure itself by the communication unit 22 does not relate directly to the present invention, either, and well-known correspondence procedures (for example, a mobile phone line network including communication base stations and a network communication using the Internet circuit network, etc.) may be employed. Thereby, as will be mentioned later, current location information (or destination information and/or direction-of-movement information, etc. of vehicle 10) can be received from the vehicle 10, and/or advertisement information which comprises an image (picture), a message, etc. can be transmitted (delivered) to the vehicle 10. Moreover, as will be mentioned later, results information which expresses sales results of a advertised good, i.e., a sales volume, sales, etc. can be received from a predetermined store 30, and/or the remuneration (reward point) based on results information can be transmitted (paid back) to the vehicle 10 which is an advertisement deliverer (more particularly, a user of the vehicle 10).

The memory unit 23 contains a storage medium (such as a hard disk and semiconductor memory) and a drive device for the storage medium, and memorizes various programs including a below-mentioned program which the information management server 21 requires for comprehensively controlling the operation of the information management center 20 and various data preliminarily or updatably. And in a predetermined storage location of the memory unit 23, a user information database 23a which memorizes, in a searchable manner, information about a user who can use the advertisement presentation system, including information about the advertisement deliverer who is the user of the vehicle 10 which can serve as an advertisement display medium, for example, in relation to unique identification information preliminarily assigned to the communication unit 13 disposed on the vehicle 10, etc., an advertisement information database 23b which memorizes, in a searchable manner, advertisement information created for each business operator who wishes an advertisement display, a reward processing information database 23c which memorizes, in a searchable manner, the reward rate of the point given back according to the amount of change in sales results (a sales volume and/or a sales price (sales)) in the store 30 for each advertised good, and a store location information database 23d which memorizes, in a searchable manner, residence site of the store 30 which sells the advertised good using map data etc. are constituted.

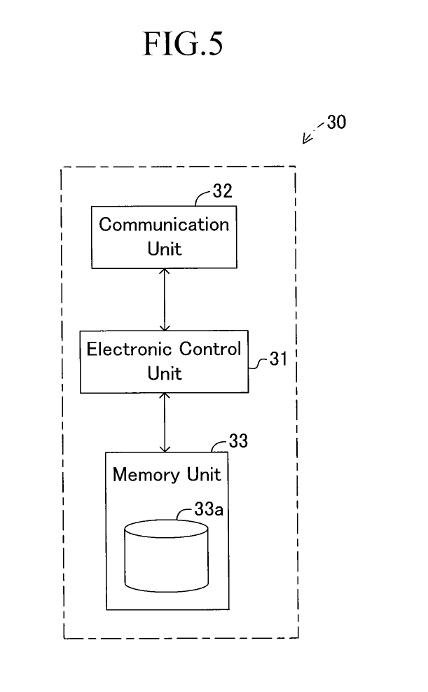

The store 30 sells the advertised good which is displayed and advertised on the body display part 11 of the vehicle 10, and may be, for example, a supermarket, a convenience store, a vending machine, etc. And the store 30 comprises a computer device which comprises the electronic control unit 31, the communication unit 32, and the memory unit 33, as schematically shown in FIG. 5.

The electronic control unit 31 is a microcomputer which comprises CPU, ROM, RAM, etc. as main component parts, and comprehensively controls the operation of the store 30 by executing various programs. For this reason, to the electronic control unit 31, the communication unit 32 and the memory unit 33 are electrically connected so that they can communicate respectively.

The communication unit 32 enables various communications with the information management center 20. In addition, the correspondence procedure itself by the communication unit 32 does not relate directly to the present invention, either, and well-known correspondence procedures (for example, Bluetooth (registered trademark) and Wi-Fi (registered trademark), short-distance and middle-distance communications using NFC (Near Field Communication), a mobile phone line network including communication base stations and a network communication using the Internet circuit network, etc.) may be employed. Thereby, as will be mentioned later, request information expressing the Request to Send (RTS) of results information which expresses sales results of a advertised good, i.e., a sales volume, sales, etc. can be received from the information management center 20, and/or the corresponding results information can be transmitted to the information management center 20 according to this request information.

The memory unit 33 contains a storage medium (such as a hard disk and semiconductor memory) and a drive device for the storage medium, and memorizes various programs and various data. And in a predetermined storage location of the memory unit 33, a sales results database 33a which memorizes, in a searchable manner, results information which expresses the sales results of the various goods sold at the store 30, i.e., a sales volume, sales, etc., for every goods is built.

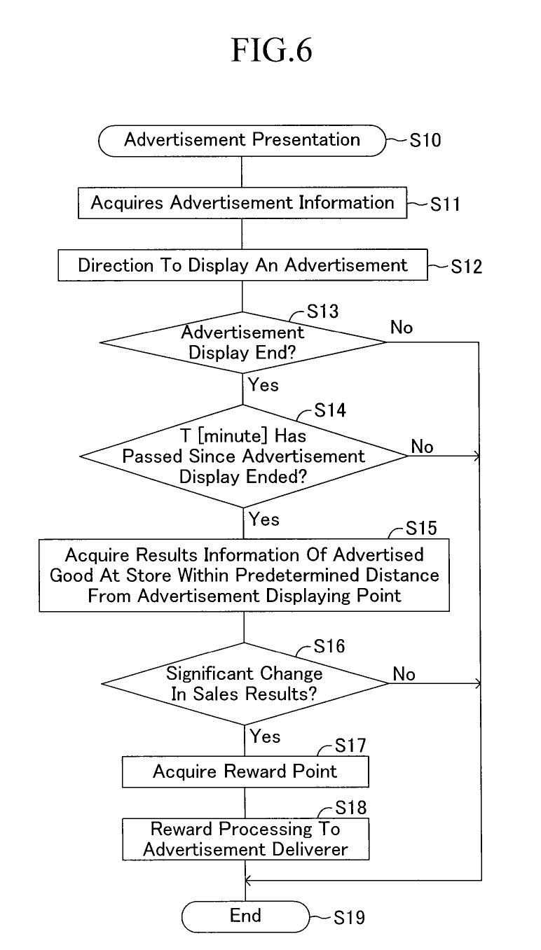

Next, the operation of an information management center 20 in a advertisement presentation system according to the present embodiment, which is constituted by the vehicle 10, the information management center 20, and the store 30 will be explained in detail using FIG. 6.

The user of the vehicle 10 (advertisement deliverer) preliminarily registers at the information management center 20 to permit the information management server 21 of the information management center 20 to use the body display part 11 of the vehicle 10 being used for an advertisement display, for example, by using an operation input means (not shown) disposed in a cabin of the vehicle 10 or his/her own information terminal device. In addition, in the information management center 20, the information management server 21 updatably memorizes, for example, the permission of use in the user information database 23a built in the memory unit 23. And in such a state where the advertisement deliverer (user) permits to use the body display part 11 of the vehicle 10 for an advertisement display, the electronic control unit 12 of the vehicle 10 transmits the current location information acquired from the location detection unit 15 to the information management center 20 through the communication unit 13. At this time, the unique identification information preliminarily assigned to the communication unit 13 is given to the current location information to be transmitted, and it is transmitted to the information management center 20.

In the information management center 20, the information management server 21 receives the unique identification information and current location information which were transmitted by the electronic control unit 12 of the vehicle 10 through the communication unit 22. And the information management server 21 temporarily memorizes the unique identification information and current location information which were received and acquired to a predetermined memory site of the memory unit 23. On the other hand, the information management server 21 has started execution of the advertisement presentation program shown in FIG. 6 at Step S10 with a predetermined short time interval, and acquires advertisement information corresponding to said received current location information at Step S11.

Here, the advertisement information memorized in the advertisement information database 23b will be explained concretely. In the information management center 20, for example, based on the advertising contents information of choice acquired from each business operator who wishes an advertisement display, the information management server 21 creates advertisement information and memorizes the same in a searchable manner in the advertisement information database 23b. Namely, the information management server 21 specifies an area in which the advertisement should be displayed (presented) and a period of time during which the advertisement is displayed (presented), for example, based on the advertising contents information of choice expressing the advertising contents of choice, which were acquired from each business operator. And while specifying the image (picture) data expressing the advertisement which was offered by the business operator in relation to this area and period of time, it specifies the display embodiment of this specified image (picture) data in relation thereto. Thereby, the information management server 21 creates advertisement information defining the details of advertising contents for each area in which each business operator expects an advertisement display and memorizes, in a searchable manner, this created advertisement information in the advertisement information database 23b for each area, for example.

For this reason, as mentioned above, the information management server 21 searches the advertisement information database 23b using the current location of the vehicle 10 expressed using the current location information memorized temporarily, and extracts and acquires advertisement information including an area reachable from this current location. And the information management server 21 will go to Step S12 when it acquires corresponding advertisement information.

In Step S12, the information management server 21 transmits direction information which provides direction to display an advertisement on the body display part 11 based on the advertisement information transmitted (delivered) to the electronic control unit 12 of the vehicle 10, while transmitting (delivering) the advertisement information acquired at said Step S11 to the vehicle 10 through the communication unit 22. In addition, in the search processing in said Step S11, when advertisement information including an area reachable from the current location does not exist, the information management server 21 transmits (delivers) reporting information expressing that any corresponding advertisement information does not exist to the vehicle 10.

In the vehicle 10, the electronic control unit 12 receives the advertisement information and direction information transmitted from the information management center 20, or the reporting information, through the communication unit 13. And the electronic control unit 12 memorizes, in a searchable manner, the received and acquired advertisement information and direction information, or the reporting information in the predetermined memory site of the memory unit 14. In addition, when the reporting information is acquired from the management server 21 of the information management center 20, the electronic control unit 12 reports to a user that the advertisement to be displayed does not exist, for example, from the display or speaker disposed in the cabin, since any corresponding advertisement information does not exist within the area which the vehicle 10 can reach.

And the electronic control unit 12 compares a current location of the vehicle 10 detected by the location detection unit 15 with the area where the advertisement included in the advertisement information acquired from the information management center 20 is displayed, according to direction information, and judges whether the current location of the vehicle 10 exists in the area where the advertisement should be displayed. Moreover, the electronic control unit 12 judges whether the present time is in the period of time when the advertisement is displayed based on the period of time when the advertisement included in the advertisement information acquired from the information management center 20 should be displayed. And the electronic control unit 12 displays the advertisement with the body display part 11 based on the advertisement information when the current location of the vehicle 10 exists in the area where the advertisement should be displayed and the present time is in the period of time when the advertisement should be displayed. Thereby, an advertisement can be presented to general public (viewer) who exist in the surroundings of the vehicle 10. The electronic control unit 12 is configured so as to transmit display start information expressing that the advertisement display has started to the information management center 20 when the advertisement based on advertisement information is thus displayed on the body display part 11. On the other hand, the electronic control unit 12 is configured so as to transmit display end information expressing that the advertisement display has been ended to the information management center 20 after the period of time to display has passed and advertisement display has been ended based on advertisement information.

For this reason, in the information management center 20, when the information management server 21 receives and acquires the display end information from the electronic control unit 12 of the vehicle 10 and the advertisement display with the body display part 11 of the vehicle 10 has been ended at Step S13, it will be judged as “Yes” and it will progress to Step S14. On the other hand, when the display end information has been not yet received or acquired, it will be judged as “No” and it will progress to Step S19, and the information management server 21 will once end execution of the advertisement presentation program. And execution of the program will be again started at Step S10 after progress of predetermined short time period.

In Step S14, the information management server 21 judges whether a predetermined time T [minute] has passed or not after the advertisement display with the body display part 11 of the vehicle 10 was ended. Namely, when the predetermined time T [minute] has passed after acquiring the display end information from the electronic control unit 12 of the vehicle 10, the information management server 21 will judge as “Yes” and it will progress to Step S15. On the other hand, when the predetermined time T [minute] has not yet passed after receiving the display end information, the information management server 21 will judge as “No”, and it will progress to Step S19, and the information management server 21 will once end execution of the advertisement presentation program. And execution of the program will be again started at Step S10 after progress of predetermined short time.

In Step S15, the information management server 21 searches the store 30 which exists within a predetermined distance from the current location of the vehicle 10 which displayed the advertisement based on advertisement information (advertisement displaying point), as shown in FIG. 1. And the information management server 21 acquires the results information of the advertised good advertised using the body display part 11 of the vehicle 10 from the searched store 30. Namely, the information management server 21 searches the store location information database 23d using the advertisement displaying point, and extracts the store 30 which exists within the predetermined distance from the advertisement displaying point. And the information management server 21 transmits the request information which requests transmission of the results information of the advertised good to the extracted store 30. In addition, although the request information is transmitted in order to acquire (collect) results information after the predetermined time T [minute] has passed since the advertisement display was ended in the present embodiment, it is also possible to transmit the request information immediately after the advertisement display was ended so that the information management server 21 may start acquisition (collection) of results information immediately after the end of the advertisement display.

At the store 30, the electronic control unit 31 receives the request information transmitted from the information management center 20 through the communication unit 32. And the electronic control unit 31 searches the sales results database 33a built in the predetermined memory site of the memory unit 33 using information which specifies the advertised good contained in the request information and, as for the results information of the advertised good, the results information until the predetermined time T [minute] has passed after the electronic control unit 12 of the vehicle 10 ends the advertisement display, i.e. the results information within the predetermined time T [minute] is acquired. And the electronic control unit 31 transmits the acquired results information of the advertised good to the information management center 20 through the communication unit 32.

In the information management center 20, the information management server 21 receives the results information of the advertised good transmitted from the electronic control unit 31 of the store 30 through the communication unit 22. And the information management server 21 receives and acquires the results information of the advertised good and memorizes it temporarily in the predetermined memory site of the memory unit 23, and then it will progress to Step S16.

In Step S16, the information management server 21 judges whether there is a significant change in the sales results acquired from the store 30 and temporarily memorized in the predetermined memory site of the memory unit 23 at said Step S15, based on the results information of the advertised good. Specifically, for example, when the sales results until the predetermined time T [minute] has passed since the electronic control unit 12 of the vehicle 10 ends the advertisement display, in other words, the sales volume and/or sales price (sales) of the advertised good, has a significant change such that it exceeds a predetermined standard (namely, a predetermined sales volume and/or sales price (sales)), the information management server 21 will judge it as “Yes” and it will progress to Step S17. On the other hand, when the sales results until the predetermined time T [minute] has passed since the electronic control unit 12 of the vehicle 10 ends the advertisement display does not have a significant change such that it exceeds the predetermined standard, the information management server 21 will judge it as “No” and it will progress to Step S19, and the information management server 21 will once end execution of the advertisement presentation program. And execution of the program will be again started at Step S10 after progress of predetermined short time.

In Step S17, the information management server 21 acquires the reward point according to the significant change of sales results based on the judgment processing in said Step S16. Namely, for example, the information management server 21 calculates the amount of change in sales results (namely, the sales volume and/or a sales price (sales)) of the advertised good after the electronic control unit 12 of the vehicle 10 ends the advertisement display before the predetermined time T [minute] has passed, based on the results information of the advertised good acquired at said Step S15. And the information management server 21 searches the reward processing information database 23c using the computed amount of change in sales results, acquires the reward rate corresponding to the computed amount of change in sales results, and acquires a reward point based on this reward rate. When the information management server 21 thus acquires the reward point, it will progress to Step S18.

In Step S18, the information management server 21 transmits reward information expressing the reward point acquired at said Step S17, to the user who permitted use of the body display part 11 of the vehicle 10 for the advertisement display, i.e., the advertisement deliverer, and performs a reward processing. Namely, for example, the information management server 21 searches the user information database 23a using the unique identification information transmitted together with the current location information of the vehicle 10, and specifies the advertisement deliverer. And the information management server 21 transmits the reward information to the vehicle 10 which the specified advertisement deliverer owns or the information terminal device which the advertisement deliverer uses and performs the reward processing while accumulating the reward point in the user information database 23a in relation to the specified advertisement deliverer.

When the reward processing is thus performed, to the user of the vehicle 10, i.e., the advertisement deliverer, the number of reward points (or the amount of money) given back as remuneration at this time is displayed, for example, on the display disposed in the cabin of the vehicle 10 or the display of the information terminal device being used, based on the reward information transmitted from the information management center 20, while the store at which this reward point can be used, etc. is also displayed. Thereby, it becomes possible for the advertisement deliverer to use the reward point given back.

In addition, as for use of the reward point, for example, it may be configured so that, when the advertisement deliverer (user of the vehicle 10) does some shopping at the store in which reward point is available, the reward point accumulated in the information management center 20 is automatically consumed, for example, to discount the charge of shopping, by inputting identification information, such as user ID etc., into a terminal unit disposed in the store, by making settlement through a short-distance wireless communication using a mobile information terminal device which the advertisement deliverer (user of the vehicle 10) possesses, or by making settlement using a credit card which the advertisement deliverer (user of the vehicle 10) possesses.

Thus, when the information management server 21 performs the reward processing to the advertisement deliverer at said Step S18, it will progress to Step S19. And the information management server 21 will once end execution of the advertisement presentation program at Step S19, and will start execution of the program at Step S10 again after progress of predetermined short time.

As can be understood from the above explanation, in accordance with this first embodiment, when a predetermined advertisement for advertising an advertised good is displayed (presented) with the body display part 11 of the vehicle 10 as an advertisement presentation means (advertisement presentation device), based on advertisement information provided from an information management center 20 as an advertisement provision means (advertisement provision device), the results information about change of the sales results of the advertised good which changes with the display (presentation) can be acquired, and the reward point as remuneration to be paid to advertisement presentation based on this results information can be determined. Here, in this first embodiment, the results information about change of the sales results of the advertised good after the predetermined time T [minute] has passed since the predetermined advertisement display on the body display part 11 of the vehicle 10 ended can be acquired from the store 30 which exists within the predetermined distance from the location of the vehicle 10 (body display part 11).

Thereby, since the change of the sales results of the advertised good expressed by the results information is correlated with the fact that the predetermined advertisement is presented by the body display part 11 of the vehicle 10, the advertising effectiveness accompanying presenting the advertisement to general public can be evaluated appropriately and a reward point can be determined based on the results information. Moreover, since the results information can be acquired from the store 30 which exists within the predetermined distance from the vehicle 10 (body display part 11) and sells the advertised good through a network, for example, even when a viewer who looked at the predetermined advertisement displayed by the body display part 11 of the vehicle 10 (advertisement receiver) purchases the advertised good using the store 30 established on the Internet, exact results information can be acquired and the suitable reward point to advertisement presentation can be determined.

### b. Second Embodiment

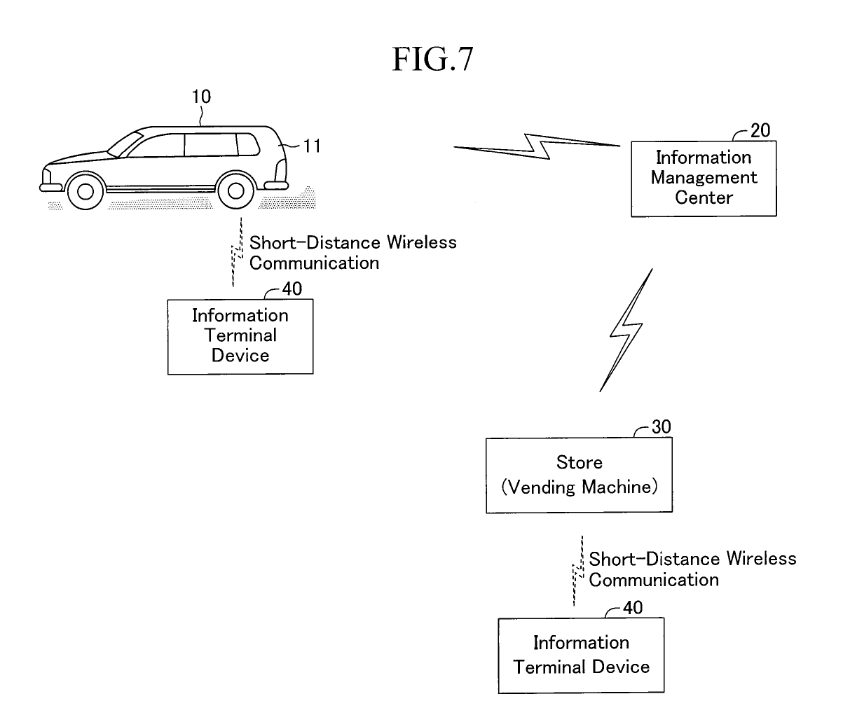

Next, an advertisement presentation system according to the second embodiment of the present invention will be explained hereafter using a drawing. In addition, hereafter, when explaining the second embodiment in detail, the same mark is given to the same portion as the above-mentioned first embodiment and the detailed explanation thereof will be omitted. FIG. 7 is a schematic block diagram schematically showing an advertisement presentation system according to the second embodiment. This advertisement presentation system in the second embodiment comprises a vehicle 10, an information management center 20, a store 30, and an information terminal device capable of short-distance wireless communications with the vehicle 10 and store 30. And in this advertisement presentation system, the vehicle 10 displays an advertisement based on advertisement information showing the advertisement transmitted from the information management center 20 while delivering the advertisement information to the information terminal device 40 which exists in the surroundings of the vehicle 10, remuneration (reward point) is paid to a user of the vehicle 10, i.e., an advertisement deliverer, and a user of the information terminal device 40, i.e., an advertisement receiver, due to the fact that the user of the information terminal device 40 purchases an advertised good at the store 30 based on the advertisement information delivered thereto. Thus, suitable remuneration can be paid to the advertisement receiver who purchased the advertised good based on the advertisement information delivered through the advertisement deliverer, who offered the vehicle 10 as an advertisement display medium, and the vehicle 10 by constituting this advertisement presentation system.

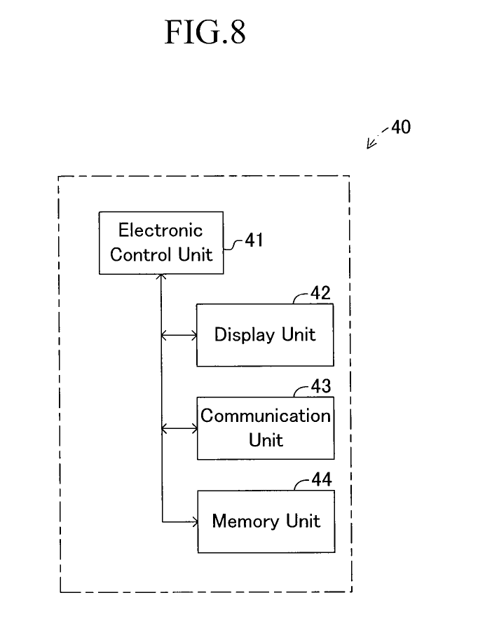

The information terminal device 40 can be moved with a user who possesses the same and, for example, a cellular phone, a smart phone, a tablet type terminal, a notebook PC, etc. can be adopted for it. When the advertisement receiver who is a user of the information terminal device 40 is located in the surroundings of the vehicle 10, the information terminal device 40 is configured so as to acquire and accumulate advertisement information through this vehicle 10, and to transmit purchase history information (advertised good purchase information) that expresses the history of the advertised good purchased at the store 30 to the information management center 20 based on this accumulated advertisement information. For this reason, the information terminal device 40 is equipped with an electronic control unit 41, a display unit 42, a communication unit 43, and a memory unit 44 as schematically shown in FIG. 8.

The electronic control unit 41 is a microcomputer which comprises CPU, ROM, RAM, etc. as main component parts, and comprehensively controls the operation of the information terminal device 40 by executing various programs. For this reason, to the electronic control unit 41, the display unit 42, the communication unit 43, and the memory unit 44 are electrically connected so that they can communicate respectively.

The display unit 42 is a touch-sensitive liquid crystal display combining with an indicating part and an operating part. The communication unit 43 enables various communications among the vehicle 10, the information management center 20, and the store 30. In addition, the correspondence procedure itself by the communication unit 43 does not relate directly to the present invention, and well-known correspondence procedures (for example, Bluetooth (registered trademark) and Wi-Fi (registered trademark), short-distance and middle-distance communications using NFC (Near Field Communication), a mobile phone line network including communication base stations and a network communication using the Internet circuit network, etc.) may be employed. Thereby, as will be mentioned later, by using the communication unit 43, the electronic control unit 41 can carry out short-distance wireless communications with the electronic control unit 12 of the vehicle 10 or the electronic control unit 31 of the store 30 to transmit and receive a variety of information (specifically, unique identification information including a MAC address etc., and advertisement information etc.), or can carry out network communication between the information management server 21 of the information management center 20 to transmit purchase history information. The memory unit 44 comprises a storage media, such as a hard disk and semiconductor memory, and a drive equipment of the storage medium, and memorizes various programs and various data updatably.

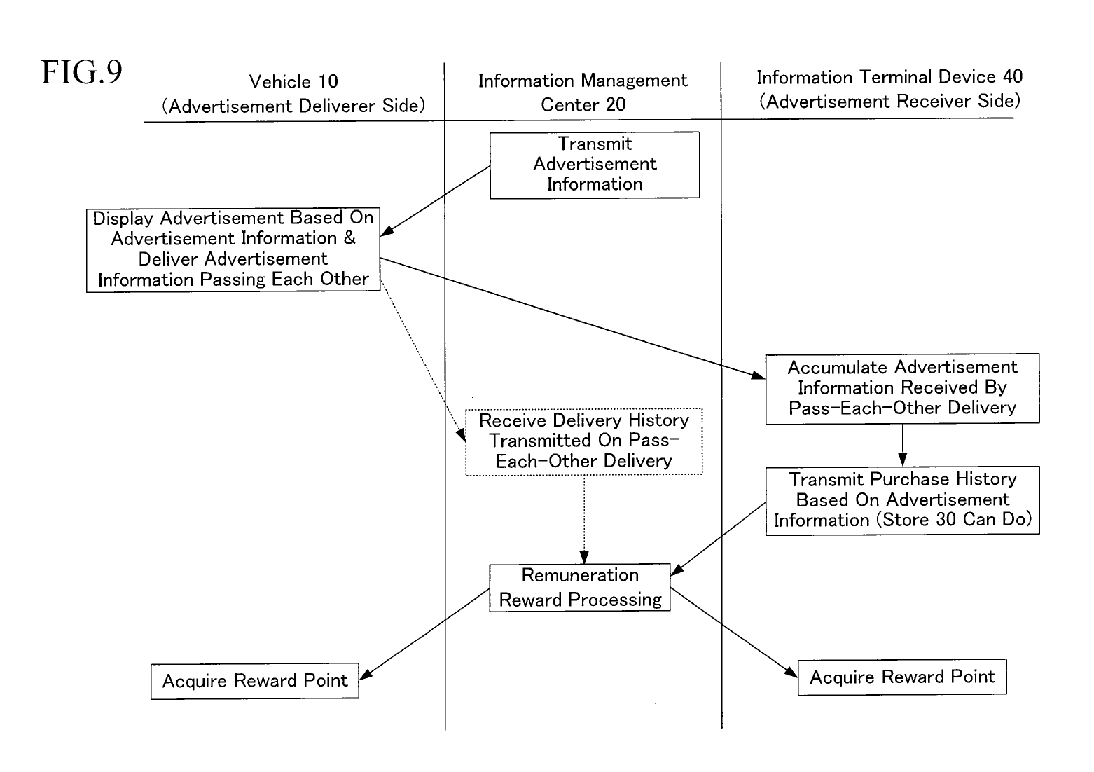

Next, the operation of an advertisement presentation system of the second embodiment constituted by the vehicle 10, the information management center 20, the store 30, and the information terminal device 40 will be explained in detail using the time chart shown in FIG. 9.

First, in this second embodiment, the user of the information terminal device 40 (advertisement receiver) registers the identification information for identifying himself or herself into the user information database 23a built in the memory unit 23 of the information management center 20. Specifically, the user of the information terminal device 40 accesses the information management center 20 through the communication unit 43, uses an input function of the display unit 42 to input the unique identification information preliminarily assigned to the information terminal device 40 (specifically, a MAC address and a telephone number etc.), and transmits the same to the information management center 20. In addition, it is configured so that the unique identification information of the information terminal device 40 (especially, a MAC Address) may be automatically given and transmitted when the user accesses the information management center 20 through the communication unit 43.

In the information management center 20, the information management server 21 receives and acquires the identification information and unique identification information transmitted by the user who possesses the information terminal device 40 (advertisement receiver) through the communication unit 22. And the information management server 21 makes the acquired identification information and unique identification information related with each other, and memorizes (registers) them to the user information database 23a searchably.

Moreover, also in this second embodiment, the user (namely, advertisement deliverer) of the vehicle 10 permits that the body display part 11 of the vehicle 10 is used for displaying an advertisement by the information management server 21 of the information management center 20. Thereby, for example, the electronic control unit 12 of the vehicle 10 transmits the current location information acquired from the location detection unit 15 to the information management center 20 through the communication unit 13 similarly to the above-mentioned first embodiment.

In the information management center 20, the information management server 21 receives and acquires the current location information and unique identification information which were transmitted from the vehicle 10 which can serve as an advertisement display medium through the communication unit 22. And, in accordance with the time chart shown in FIG. 9, the information management server 21 extracts and acquires advertisement information including an area reachable from the current location expressed using the current location information acquired from the vehicle 10 from the advertisement information database 23b, for example, similarly to the above-mentioned first embodiment, and transmits (delivers) direction information which directs to display an advertisement on the body display part 11 based on the advertisement information, along with this advertisement information, to the vehicle 10.

In the vehicle 10, the electronic control unit 12 receives and acquires the advertisement information and direction information which were transmitted from the information management center 20 through the communication unit 13, and memorizes temporarily to the predetermined memory site of the memory unit 14. And the electronic control unit 12 displays the advertisement based on the acquired advertisement information on the body display part 11 in accordance with the direction information. Thereby, an advertisement which a business operator wishes is effectively displayed to those who are located outside the vehicle 10.

on the other hand, when the user who possesses the information terminal device 40 (advertisement receiver) exists around the vehicle 10 or the vehicle 10 are running around the user who possesses the information terminal device 40 (advertisement receiver), the electronic control unit 12 of the vehicle 10 and the electronic control unit 41 of the information terminal device 40 communicate mutually through the communication unit 13 and the communication unit 43 respectively (what is called passing-each-other communication).

Namely, the electronic control unit 12 of the vehicle 10 is always searching whether a candidate for communication, specifically the information terminal device 40 which has the communication unit 43, exists around the vehicle 10 or not, using Bluetooth (registered trademark) or Wi-Fi (registered trademark) using the communication unit 13, or a short-distance wireless communication by NFC. And if the information terminal device 40 which is a candidate for communication exists, the electronic control unit 12 of the vehicle 10 will exchange the MAC address which is unique identification information mutually between the electronic control units 41 of the information terminal device 40 which is a candidate for communication, for example, and will establish a short-distance wireless communication. In addition, the MAC address which is the exchanged unique identification information is equivalent to the communication results information in the present invention. And the electronic control unit 12 of the vehicle 10 transmits (delivers) the advertisement information acquired from the information management center 20 as mentioned above to the information terminal device 40 using the short-distance wireless communications established in this way.

Then, as shown in FIG. 9, in the information terminal device 40, the electronic control unit 41 accumulates and memorizes the advertisement information transmitted (delivered) from the electronic control unit 12 of the vehicle 10 (what is called passing-each-other delivery) and the exchanged unique identification information (MAC address) in relation to each other in the predetermined memory site of the memory unit 44 searchably. Thus, when advertisement information and unique identification information are related mutually and accumulated into the memory unit 44 by passing-each-other delivery, the electronic control unit 41 will inform the user (advertisement receiver) of the fact that advertisement information has been acquired, for example, using the display unit 42.

The user of the information terminal device 40 (advertisement receiver) purchases the advertised good being currently advertised by advertisement information at the store 30, for example, in accordance with the information that the advertisement information being currently displayed on the display of the display unit 42 was acquired. At this time, the user (advertisement receiver) uses a well-known electronic banking using the information terminal device 40 when purchasing an advertised good. Namely, the electronic control unit 41 of the information terminal device 40 communicates with the electronic control unit 31 of the store 30 mutually and carries out an electronic banking of the advertised good which was purchased, using the short-distance wireless communication by NFC which uses the communication unit 43 and the communication unit 32. Thus, by carrying out electronic banking, the electronic control unit 41 acquires the purchase history information expressing the fact that the advertised good was purchased and its purchase price (sales price) from the electronic control unit 31 of the store 30, and relates this acquired purchase history information with the advertisement information on the advertised good, in other words, relates the purchase history information, advertisement information, and the unique identification information on the vehicle 10 mutually, and memorizes the same in a predetermined memory site of the memory unit 44 searchably.

Then, the electronic control unit 41 transmits the purchase history information memorized in the predetermined memory site of the memory unit 44 to the information management center 40 using the communication unit 43, as shown in FIG. 9. At this time, the electronic control unit 41 also transmits the unique identification information of the vehicle 10 related with purchase history information within the memory unit 44, and the unique identification information on the information terminal device 40, to the information management center 40, as well.

In addition, as for transmission of this purchase history information to the information management center 40, the electronic control unit 31 of the store 30 is also able to transmit the purchase history information on an advertised good through the communication unit 32 in addition to or in place of the transmission by the electronic control unit 41 of the information terminal device 40 through the communication unit 43 as mentioned above. In this case, when memorizing the advertisement information acquired by passing-each-other delivery to the memory unit 44, the electronic control unit 41 memorizes the unique identification information (MAC address) of the vehicle 10 which delivered the advertisement information by passing-each-other delivery and the unique identification information (MAC address) of the information terminal device 40 which acquired the advertisement information, for example, after bar-coding them.

And, for example, the user of the information terminal device 40 presents the target advertisement information to a salesclerk of the store 30 using the display unit 42 and has a bar code, which is displayed in relation to this advertisement information, read at the time of the accounts of a advertised good. Thereby, the electronic control unit 31 of the store 30 can transmit the unique identification information of the vehicle 10 and the unique identification information of the information terminal device 40 to the information management center 20 through the communication unit 32 along with the purchase history information on the advertised good purchased by the user of the information terminal device 40 (advertisement receiver).

In the information management center 20, as shown in FIG. 9, the information management server 21 receives and acquires the purchase history information transmitted from the information terminal device 40 (or store 30), the unique identification information of the vehicle 10, and the unique identification information of the information terminal device 40 through the communication unit 22. And the information management server 21 temporarily memorizes each acquired information in the predetermined memory site of the memory unit 23.

Then, the information management server 21 acquires the purchase price (sales price) contained in the purchase history information, when the user of the information terminal device 40 (advertisement receiver) who acquired the advertisement information from the vehicle 10 by passing-each-other delivery has purchased the target advertised good, based on the acquired purchase history information. And the information management server 21 searches the reward processing information database 23c using the acquired purchase price (sales price), acquires the reward rate corresponding to the purchase price (sales price), i.e., the amount of change in sales results, and determines a reward point based on this reward rate.

After a reward point is thus determined, similarly to the above-mentioned first embodiment, the information management server 21 transmits reduction information which expresses the determined reward point to the user who permitted use of the body display part 11 of the vehicle 10 for the advertisement display (advertisement deliverer) and the user of the information terminal device 40 who purchased the advertised good after seeing the advertisement display (advertisement receiver) to perform reward processing. Namely, the information management server 21 searches the user information database 23a using the unique identification information of the vehicle 10 transmitted along with the purchase history information, and specifies the advertisement deliverer. Moreover, the information management server 21 searches the user information database 23a using the unique identification information of the information terminal device 40 transmitted along with the purchase history information, and specifies the advertisement receiver. Thereby, for example, the information management server 21 accumulates a reward point in relation to the specified advertisement receiver in the user information database 23a while accumulating the reward point in relation to the specified advertisement deliverer in the user information database 23a. And the information management server 21 transmits reduction information to the information terminal device 40 which the specified advertisement receiver possesses while transmitting reduction information to the vehicle 10 which the specified advertisement deliverer owns or the information terminal device which the advertisement deliverer uses, and performs reward processing.

Thus, when reduction information is transmitted from the information management center 20 to the vehicle 10 (advertisement deliverer) and the information terminal device 40 (advertisement receiver) respectively, a reward point will be given to each of an advertisement deliverer and an advertisement receiver, as shown in FIG. 9. Specifically, as for the user of the vehicle 10, i.e., the advertisement deliverer, based on the reduction information transmitted from the information management center 20, for example, the number of reward points (or amount of money) returned as remuneration this time is displayed on a display disposed in the vehicle interior of the vehicle 10 or on a display of the information terminal device in use, along with stores where this reward point can be used, etc. On the other hand, as for the user of the information terminal device 40, i.e., the advertisement receiver, based on the reduction information transmitted from the information management center 20, the number of reward points (or amount of money) returned as remuneration this time is displayed on the display unit 42, along with stores where this reward point can be used, etc. Thereby, the advertisement deliverer and the advertisement receiver become possible to use the returned reward point similarly to the above-mentioned first embodiment.

As can be understood from the above explanation, in accordance with the above-mentioned second embodiment, based on the purchase history information, the user of the information terminal device 40 (advertisement receiver) with a track record of a short-distance wireless communication with the vehicle 10 equipped with the body display part 11 can acquire the results information corresponding to an actual purchase of the advertised good. Thereby, correlation between the fact that a predetermined advertisement is presented by the body display part 11 of the vehicle 10 and the change of the sales results of the advertised good expressed by the results information can be evaluated with a very high degree of precision, and the advertising effectiveness accompanying displaying the advertisement can be more appropriately evaluated based on this highly precise results information. Other effects are the same as those in the above-mentioned first embodiment.

b-1. Modification of Second Embodiment

In the above-mentioned second embodiment, as shown in FIG. 9, the electronic control unit 41 of the information terminal device 40 acquires the advertisement information from the electronic control unit 12 of the vehicle 10 by passing-each-other delivery and transmits the purchase history information on a purchase of the advertised good based on this advertisement information, and thereby the information management center 20 performs remuneration reward processing. In this case, as shown by a dashed line in FIG. 9, at the time of completion of transmission and reception of the advertisement information by passing-each-other delivery between the electronic control unit 12 of the vehicle 10 and the electronic control unit 41 of the information terminal device 40 (using as a trigger the completion of the passing-each-other delivery), it is also possible to start execution of remuneration reward processing in the information management center 20.

Namely, in this case, the electronic control unit 12 of the vehicle 10 memorizes the exchanged unique identification information (MAC address) in the predetermined memory site of the memory unit 14, and accesses the information management center 20 through the communication unit 13 when the passing-each-other delivery between it and the electronic control units 41 of the information terminal device 40 is completed. And the electronic control unit 12 relates mutually the unique identification information (MAC address) of the information terminal device 40 and the unique identification information (MAC address) of the vehicle 10 exchanged in connection with the passing-each-other delivery, and transmits them as communication results information.

Thereby, in the information management center 20, the information management server 21 determines a reward point based on the reduction rate determined beforehand. And the information management server 21 transmits the reduction information expressing the determined reward point to the user who permitted use of the body display part 11 of the vehicle 10 for the advertisement display (advertisement deliverer) and to the user of the information terminal device 40 who acquired advertisement information by passing-each-other delivery (advertisement receiver) to perform a reward processing. Thereby, to the user of the vehicle 10, i.e., the advertisement deliverer, based on the reduction information transmitted from the information management center 20, for example, the number of reward points (or amount of money) returned as remuneration this time is displayed on the display disposed in vehicle interior of the vehicle 10 or on the display of the information terminal device in use, along with stores where this reward point can be used, etc. On the other hand, to the user of the information terminal device 40, i.e., the advertisement receiver, based on the reduction information transmitted from the information management center 20, the number of reward points (or amount of money) returned as remuneration by this passing-each-other delivery is displayed on the display unit 42, along with stores where this reward point can be used, etc. Thereby, it becomes possible, especially for the advertisement receiver, to use previously returned reward points, for example, when purchasing the advertised good.

### c. Other Modifications

In the above-mentioned first embodiment, second embodiment and their modifications, the advertisement information transmitted (delivered) to the vehicle 10 from the information management center 20 is not particularly limited, and it may be any kind of advertisement information, in other words, any kind of information, as long as it is an advertisement which should be displayed in an area reachable from the current location of the vehicle 10 which can serve as an advertisement display medium. Namely, in the above-mentioned first embodiment, second embodiment and their modifications, by clarifying correlation between distribution (display) of an advertisement (information) through the body display part 11 of the vehicle 10 and a significant change arising in the sales of an advertised good, etc., suitable remuneration is paid to an advertisement deliverer or an advertisement receiver.

By the way, in order to promote the purchase of an advertised good with more effective advertisement display, for example, it is effective to change the contents and/or display embodiment of advertisement (information) which is delivered (displayed) through the body display part 11 of the vehicle 10. Although modifications in which the contents and/or display embodiment of advertisement (information) which is delivered (displayed) through the body display part 11 of the vehicle 10 will be explained hereafter, the same mark is given to the same portion as each of the above-mentioned embodiments, and the detailed explanation thereof will be omitted. Namely, in the following explanation, the modification on an advertisement display will be shown, and portions other than an advertisement display are carried out quite similarly to each of the above-mentioned embodiments and the above-mentioned modifications.

c-1. Case where the Display Contents of Advertisement (Information) are Changed in Accordance with an Advertisement Receiver's Concern

As mentioned above, generally, advertising effectiveness, what is called a propaganda effect, have a tendency in which an effect goes up or down depending on the level of concern and/or the presence or absence of interest of a person who looks at the displayed advertisement or information (viewer). For this reason, the case where the contents of the advertisement (information) delivered (displayed) through the body display part 11 of the vehicle 10 are changed in accordance with an advertisement receiver's (or advertisement deliverer's) concern will be explained.

In this case, preference information and relationship information are memorized in the user information database 23a built in the memory unit 23 of the information management center 20. In a concrete explanation, the user of the vehicle 10 (advertisement deliverer) accesses the information management center 20, for example, using an operation unit (not shown) disposed in the vehicle 10 and/or his (or her) own information terminal device. And the user of the vehicle 10 transmits, as his (or her) own preference, in addition to his (or her) user name and/or user ID, his (or her) current concerns and/or interests (for example, matters about a current job and/or matters about a hobby, etc.), matters about his (or her) own preferences (for example, a product which he (or her) has used regularly, or information relevant to this product, etc.) to the information management center 20, for example, along with the unique identification information (specifically, a MAC address, a telephone number, etc.) beforehand assigned to the communication unit 13 of the vehicle 10. In addition, it is configured so that the unique identification information of the communication unit 13 is automatically given and transmitted when the user accesses the information management center 20 through the communication unit 13 of the vehicle 10.

Further, according to the relationships with a person relevant to the user himself (or herself), specifically a person in a specific relation, whose background can be revealed without any problems, such as a family, friends, friends on SNS, acquaintances, fellow students, fellow citizens or people in the same business, etc., the user of the vehicle 10 classifies the unique identification information (specifically, a MAC address, a telephone number, etc.) beforehand assigned to the information terminal device 40 which the person relevant to the user himself (or herself) possesses when they become viewers (alternatively, the communication unit 13 of the vehicle 10 on which they are), and transmits it to the information management center 20. In addition, as for the unique identification information of the information terminal device 40 which the person relevant to the user himself (or herself) possesses (alternatively, the communication unit 13 of the vehicle 10 on which they are), the information management server 21 of the information management center 20 can acquire a MAC address by inquiring of other management centers about device information, for example, based on the transmitted telephone number.

In the information management center 20, the information management server 21 receives and acquires a variety of information expressing the above-mentioned preference transmitted along with the unique identification information of the communication unit 13 by the user of the vehicle 10 and/or the unique identification information of the information terminal device 40 which the person relevant to the user himself (or herself) possesses, through the communication unit 22. And the information management server 21 relates the variety of information expressing the acquired preference with the unique identification information of the communication unit 13, and memorizes (registers) it as preference information in the user information database 23a searchably. Furthermore, the information management server 21 divides the acquired unique identification information of the information terminal device 40 according to designated relationships, relates the acquired unique identification information of each information terminal device 40 with the unique identification information of the communication unit 13, and memorizes (registers) it as relationship information in the user information database 23a searchably.

On the other hand, the user who possesses the information terminal device 40 (advertisement receiver) accesses the information management center 20 using this information terminal device 40. And the advertisement receiver transmits, as his (or her) own preference, in addition to his (or her) user name and/or user ID, his (or her) current concerns and/or interests (for example, matters about a current job and/or matters about a hobby, etc.), matters about his (or her) own preferences (for example, a product which he (or her) has used regularly, or information relevant to this product, etc.) to the information management center 20, for example, along with the unique identification information (specifically, a MAC address, a telephone number, etc.) beforehand assigned to the communication unit 43 of the information terminal device 40. In addition, it is configured so that the unique identification information of the communication unit 43 is automatically given and transmitted when the advertisement receiver accesses the information management center 20 through the communication unit 43 of the information terminal device 40.

In the information management center 20, the information management server 21 receives and acquires a variety of information expressing the above-mentioned preference transmitted along with the unique identification information of the communication unit 43 by the user who possesses the information terminal device 40 (advertisement receiver), through the communication unit 22. And the information management server 21 relates the variety of information expressing the acquired preference with the unique identification information of the communication unit 43, and memorizes (registers) it as preference information in the user information database 23a searchably.

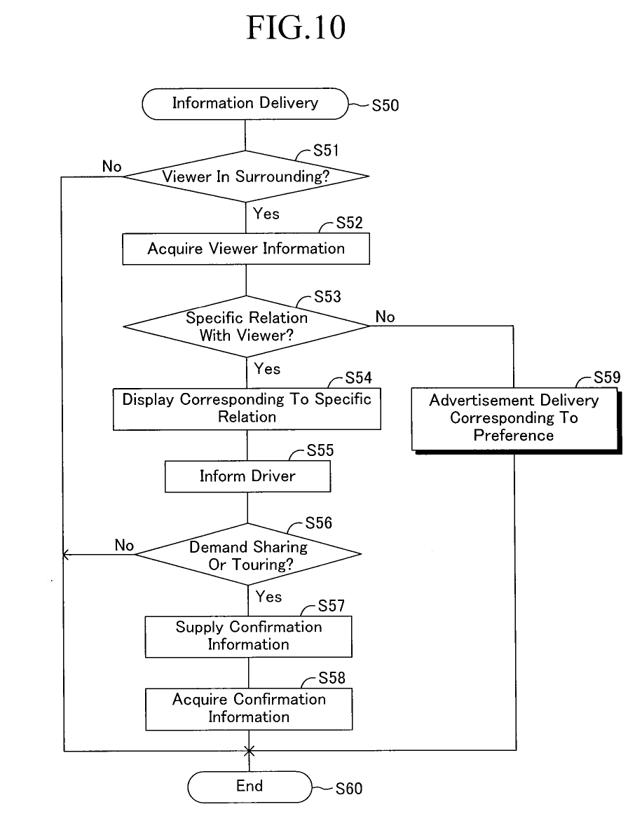

And in the state where the user of the vehicle 10 and the user who possesses the information terminal device 40 have registered the preference information and relationship information in the information management center 20 as mentioned above, when the electronic control unit 12 of the vehicle 10 and the electronic control unit 41 of the information terminal device 40 perform a passing-each-other communication mutually, the information management server 21 of the information management center 20 will execute the information delivery program shown in FIG. 10. Namely, the information management server 21 starts the information delivery program shown in FIG. 10 at Step S50 with the short predetermined time interval, and judges whether the viewer (advertisement receiver) who possessed the information terminal device 40 exists around the vehicle 10 or not at Step S51. Specifically, when the information management server 21 receives the unique identification information of the vehicle 10 and the unique identification information on the information terminal device 40 from the electronic control unit 12 of the vehicle 10 by the above-mentioned passing-each-other communication, it judges as “Yes” at Step S51 and progresses to Step S52 since the user of the information terminal device 40 (advertisement receiver) exists as a viewer in the surroundings of the vehicle 10. On the other hand, when a passing-each-other communication is not performed and any viewer (advertisement receiver) does not exist in the surroundings of the vehicle 10, the information management server 21 judges as “No” at Step S51, progresses to Step S60 to end execution of the information delivery program, and starts execution of the program again at Step S50 after progress of short predetermined time.

In Step S52, the information management server 21 searches the user information database 23a of the memory unit 23 using the unique identification information of the vehicle 10 and the unique identification information of the information terminal device 40 which were transmitted by the electronic control unit 12 of the vehicle 10, and acquires the information about the viewer (advertisement receiver) memorized (registered) in relation to the unique identification information of the information terminal device 40. In a concrete explanation, first, the information management server 21 searches the user information database 23a using the unique identification information of the vehicle 10, acquires relationship information related to this unique identification information. And when a person corresponding to the unique identification information of the information terminal device 40 (advertisement receiver) exists among specific people expressed using the acquired relationship information, it acquires corresponding relationship information. Moreover, the information management server 21 searches the user information database 23a using the unique identification information of the information terminal device 40, and when the preference information related with this unique identification information is memorized (registered), it will acquire corresponding preference information. And when the relationship information and preference information relevant to unique identification information of the information terminal device 40 can be acquired, the information management server 21 acquires each of these information as viewer information, and progresses to Step S53.

In Step S53, the information management server 21 judges whether a specific relation (specifically, a relation such as a family, friends, or acquaintances) between the user of the vehicle 10 (advertisement deliverer) and the user of the information terminal device 40 (advertisement receiver) exists or not. Namely, since there is a specific relation between the user of the vehicle 10 (advertisement deliverer) and the user of the information terminal device 40 (advertisement receiver) when relationship information could be acquired at the above-mentioned Step S52, the information management server 21 judges as “Yes” and progresses to Step S54. On the other hand, since there is no specific relation between the user of the vehicle 10 (advertisement deliverer) and the user of the information terminal device 40 (advertisement receiver) when relationship information could not be acquired at the above-mentioned Step S52, the information management server 21 judges as “No” and progresses to Step S59, and performs an “advertisement delivery routine corresponding to a preference” that will be mentioned later.

In Step S54, the information management server 21 acquires the information corresponding to the relationship with the user of the information terminal device 40 (advertisement receiver) who was judged at the above-mentioned Step S53 (including advertisement information) from the message information database 23b. In a concrete explanation, for example, when the relation with the user of the information terminal device 40 (advertisement receiver) is a family an accordance with the judgment processing in the above-mentioned Step S53, image data expressing a message and/or an image to be shared among the family, such as “Let's go home together”, will be acquired in place of advertisement information, and when relation with the user of the information terminal device 40 (advertisement receiver) is friends, image data expressing a message and/or an image to be shared among the friends, such as “Have a nice evening”, “Need a lift?”, “Let's have fun!”, will be acquired in place of advertisement information. And the information management server 21 transmits the acquired information (image data expressing an image (picture) or a message) to the vehicle 10 through the communication unit 22. When the information corresponding to the relation with the user of the information terminal device 40 (advertisement receiver) is thus transmitted to the vehicle 10, the information management server 21 progresses to Step S55.

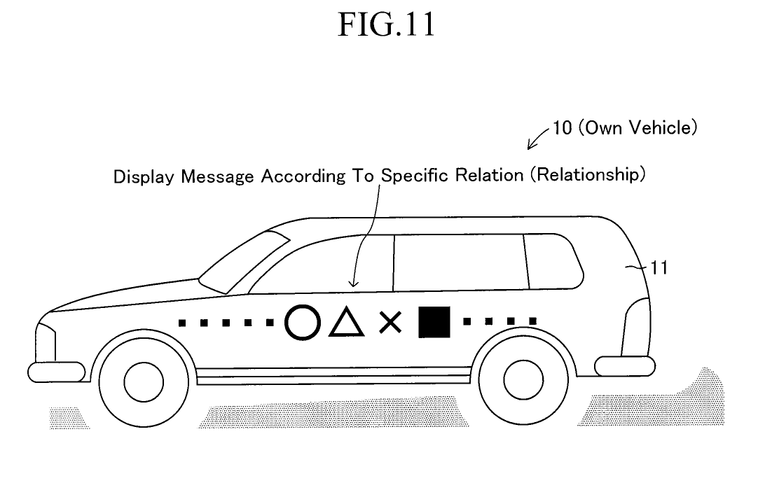

Here, in the vehicle 10, the electronic control unit 12 receives and acquires the image data transmitted by the information management server 21 of the information management center 20 through the communication unit 13, and once memorizes the acquired image data in the predetermined memory site of the memory unit 14. And the electronic control unit 12 supplies the image data memorized in the predetermined memory site of the memory unit 14 to the body display part 11 through a drive circuit. Thereby, the body display part 11 displays information (message) to the user of the information terminal device 40 in a specific relation, which exists in the surroundings of the vehicle 10, (advertisement receiver) in accordance with a predetermined display embodiment, for example, while scrolling and/or blinking the character and figure contained in the message, as schematically shown in FIG. 11. Therefore, the electronic control unit 12 of the vehicle 10 becomes able to display the information (message) which the user of the vehicle 10 (advertisement deliverer) wants to offer to the user of the information terminal device 40 (advertisement receiver), while the information (message) which is relevant (of interest) to a viewer comes to be offered (displayed) to himself (or herself) through the vehicle 10.

In Step S55, the information management server 21 informs the user of the vehicle 10 (advertisement deliverer) of the fact that predetermined information (message) is currently displayed using the body display part 11 to the user of the information terminal device 40 which has a specific relation (advertisement receiver) in place of an advertisement. Specifically, the information management server 21 transmits, through the communication unit 22, instruction information for ordering the electronic control unit 12 of the vehicle 10 to notify (inform) the user of the fact that information based on the image data transmitted at the above-mentioned Step S54 is currently displayed on the body display part 11. And the information management server 21 progresses to Step S56 when transmitting the instruction information.

Here, in the vehicle 10, the electronic control unit 12 receives and acquires the instruction information transmitted by the information management server 21 of the information management center 20 through the communication unit 13. And the electronic control unit 12 notifies (informs) of the fact that predetermined information (message) is currently displayed to the user of the information terminal device 40 in a specific relation, which exists in the surroundings of the vehicle 10, (advertisement receiver), for example, using the display and/or speaker which are carried in the vehicle interior of the vehicle 10. In addition, in this case, a notice (information) is displayed on a display when the vehicle 10 is stopping, while a sound from a speaker notifies (informs) when the vehicle 10 is running. Thereby, the user of the vehicle 10 aboard can easily grasp that information to be provided a viewer by the body display part 11 is automatically displayed.

In Step S56, the information management server 21 specific judges whether the user of the information terminal device 40 in a relation (advertisement receiver) (or the user of the vehicle 10 (advertisement deliverer)) demands to get on (ride together) the vehicle 10, for example, depending on the information displayed by the information display processing in the above-mentioned Step S54, or whether the user of the information terminal device 40 in a specific relation (advertisement receiver) is on other vehicle 10 and the user of the information terminal device 40 in a relation (advertisement receiver) (or the user of the vehicle 10 (advertisement deliverer)) demands to move while touring (running side by side) or not. Namely, the user of the information terminal device 40 (advertisement receiver) (or the user of the vehicle 10 (advertisement deliverer)) transmits request information to the information management center 20 through the communication unit 43 of the information terminal device 40 or the communication unit 13 of the vehicle 10, when demanding to ride together or touring, with respect to moving to the same destination (or the same direction), depending on the information displayed at the above-mentioned step S54. In addition, although the user of the information terminal device 40 in a specific relation (advertisement receiver) or, in some cases, the user of the own vehicle 10 (advertisement deliverer) can transmit this request information, in the following explanation, in order to make the understanding easy, a case where the user who possesses the information terminal device 40 (advertisement receiver) transmits the request information which demands riding together and the user of the information terminal device 40 on other vehicle 10 (advertisement receiver) transmits the request information which demands touring will be exemplified and explained.

When the user of the information terminal device 40 (advertisement receiver) demands to ride together or touring, the information management server 21 transmits, to the own vehicle 10, information expressing the fact that the user of the information terminal device 40 (advertisement receiver) in a specific relation with the user of the vehicle 10 (advertisement receiver). Thereby, the user of the vehicle 10 (advertisement deliverer) can grasp whether the user of the information terminal device 40 in a specific relation (advertisement receiver) is demanding riding together or touring. And, in this case, the user of the vehicle 10 (advertisement deliverer) can show whether it meets or refuses the demand by the user of the information terminal device 40 (advertisement receiver), to the information management server 21 of the information management center 20. In addition, the following explanation is based on the premise that the user of the vehicle 10 (advertisement deliverer) meets the demand by the user of the information terminal device 40 (advertisement receiver) which is a visitor.

In the information management center 20, if the information management server 21 receives and acquires the request information from the user of the information terminal device 40 (advertisement receiver) through the communication unit 22, it will judge as “Yes” at Step S56, and will progress to Step S57. On the other hand, if it does not acquire the request information from the user of the information terminal device 40 (advertisement receiver), the information management server 21 judges as “No” at Step S56, progresses to Step S60, and ends execution of the information delivery program, and starts execution of the program again at Step S50 after progress of short predetermined time.

In Step S57, the information management server 21 transmits confirmation information for confirming concrete contents to the person to whom the above-mentioned request information is transmitted, i.e., the user of the information terminal device 40 (advertisement receiver). And when the confirmation information is transmitted to the person to whom the above-mentioned request information is transmitted the partner who transmitted the above-mentioned request information, the information management server 21 progresses to Step S58.

In Step S58, the information management server 21 receives the response information which expresses the concrete contents transmitted from the user of the information terminal device 40 (advertisement receiver) in response to the confirmation information transmitted at the above-mentioned Step S17. And the information management server 21 notifies the concrete contents expressed by the response information to the user of the vehicle 10 (advertisement deliverer). Concretely, the information management server 21 transmits notice information expressing the spot (destination) or a direction where the user of the information terminal device 40 (advertisement receiver) demands riding together and touring to the vehicle 10. At this time, with respect to the demand of a touring, the information management server 21 searches for the course to the destination expressed by the response information using map data and road data which are memorized in a touring matching database 23c. Here, since the information management server 21 has acquired current location information (direction-of-movement information) from the vehicle 10, the vehicle 10 and other vehicle 10 can move while touring (running side by side) when a part or all of the searched course to the destination specified by the viewer coincides (matches) with the direction of movement of the vehicle 10. For this reason, the information management server 21 judges whether it is possible to move while touring or not, and transmits notice information including this touring propriety information to the vehicle 10.

Furthermore, in a situation where the user of the vehicle 10 (advertisement deliverer) satisfies the demand, for example, the information management server 21 transmits the image data expressing the information (message) which shows that a demand to ride together is satisfied to the own vehicle 10 when the user of the information terminal device 40 (advertisement receiver) demands to ride together, and transmits image data expressing the information (message and/or image) which makes the body display part 11 of the vehicle 10 and the body display part 11 of other vehicle 10 cooperate to raise a sense of togetherness to the vehicle 10 and other vehicle 10 when the user of the information terminal device 40 (advertisement receiver) demands a touring. And when the notice information and image data are transmitted, the information management server 21 progresses to Step S60 to end execution of the information delivery program, and starts execution of the program again at Step S50 after progress of short predetermined time.

In the vehicle 10, the electronic control unit 12 receives and acquires the notice information and image data which were transmitted by the information management server 21 of the information management center 20 through the communication unit 13. And the electronic control unit 12 notifies (informs) of, for example, the fact that the user of the information terminal device 40 (advertisement receiver) demands to ride together to a certain spot, and/or the fact that the user of the information terminal device 40 (advertisement receiver) on other vehicle 10 demands to move while touring to a certain destination, using a display and/or a speaker which are carried in the vehicle interior of the vehicle 10, based on the acquired notice information. In addition, also in this case, a notice (information) is displayed on a display when the vehicle 10 is stopping, and a sound from a speaker notifies (informs) when the vehicle 10 is running.

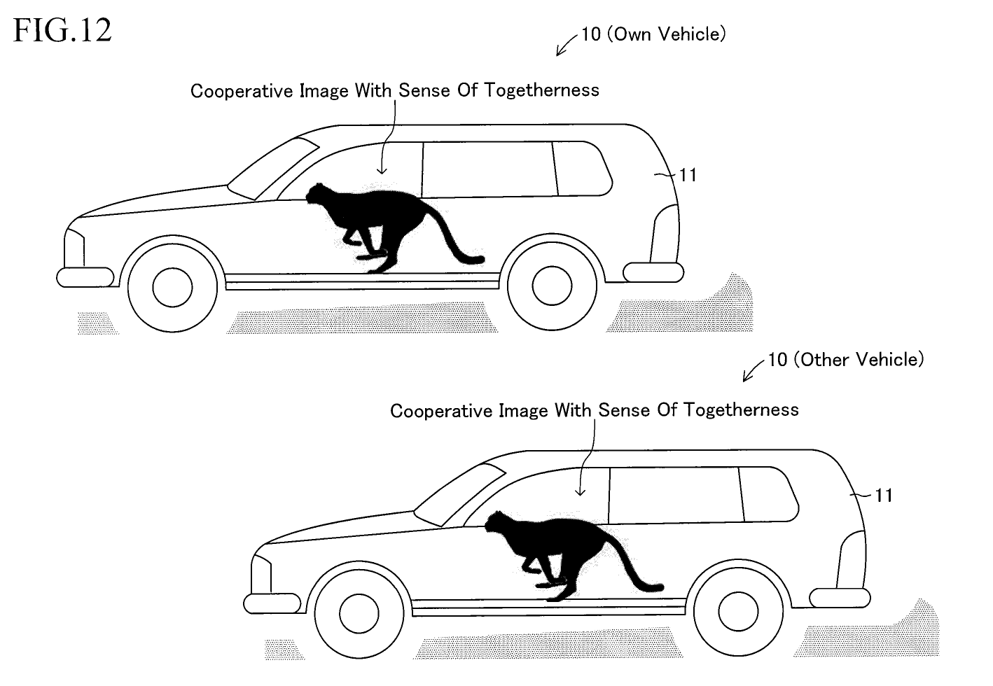

And when the user of the information terminal device 40 (advertisement receiver) demands to ride together, the electronic control unit 12 of the vehicle 10 supplies the image data acquired from the information management server 21 of the information management center 20 to the body display part 11 through a drive circuit. Thereby, to the user of the information terminal device 40 (advertisement receiver) who wishes to share the vehicle, information (message) such as “Sure!” and/or “Wait there!” can be displayed in place of an advertisement display. On the other hand, when the user of the information terminal device 40 (advertisement receiver) on other vehicle 10 demands a touring, the electronic control unit 12 of the vehicle 10 and the electronic control unit 12 of other vehicle 10 supply the image data acquired from the information management server 21 of the information management center 20 to the body display part 11 through a drive circuit, respectively. Thereby, the body display part 11 of the touring vehicle 10 and the body display part 11 of other vehicle 10 can display the information (picture) which raises a sense of togetherness while making the same cooperate mutually, for example, as schematically shown in FIG. 12.

On the other hand, when there is not a specific relation between the user of the vehicle 10 (advertisement deliverer) and the user of the information terminal device 40 (advertisement receiver) and therefore it is judged as “No” at the above-mentioned Step S53, the information management server 21 progresses to Step S59 and executes an “advertisement delivery routine corresponding to a preference” in order to display an advertisement as information (delivery). Hereafter, this “advertisement delivery routine corresponding to a preference” will be explained in detail.

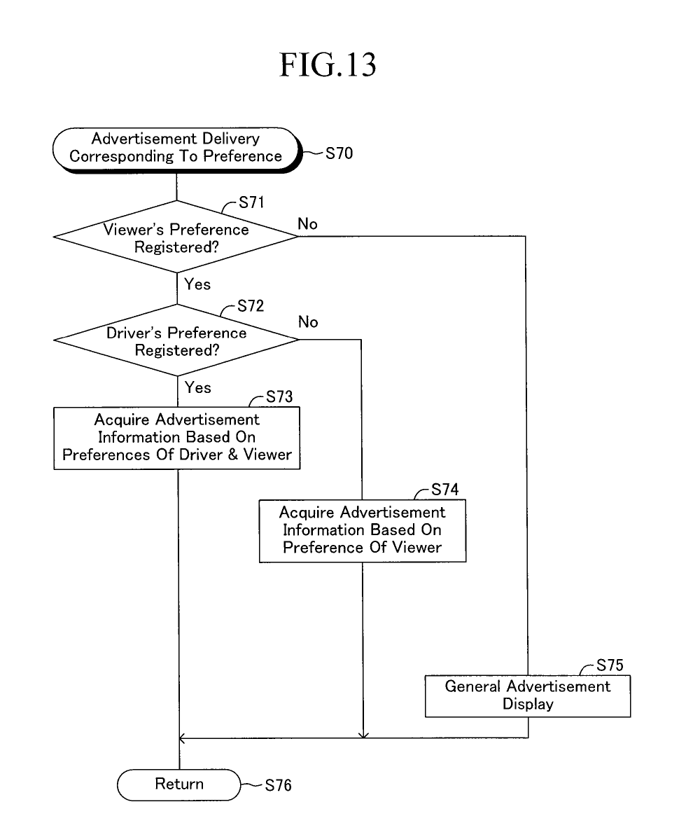

In this “advertisement delivery routine corresponding to a preference”, as shown in FIG. 13, its execution is started at Step S70, and the information management server 21 judges whether a preference is registered (contained) in the preference information of the user of the information terminal device 40 (advertisement receiver) or not at succeeding Step S71. Namely, if a preference is contained in the preference information of the user of the information terminal device 40 (advertisement receiver) acquired at the above-mentioned step S52 in the “information delivery program”, the information management server 21 will judge as “Yes” and will progress to Step S72. On the other hand, if a preference is not contained in the preference information of the user of the information terminal device 40 (advertisement receiver) at all, the information management server 21 will judge as “No” and will progress to Step S75.

In Step S72, the information management server 21 judges whether a preference is registered (contained) in the preference information of the user of the vehicle 10 (advertisement deliverer) or not. Namely, the information management server 21 searches the user information database 23a using the unique identification information of the vehicle 10, and when the preference information related with this unique identification information is memorized (registered), it will acquire corresponding preference information. And if a preference is contained in the acquired preference information of the user of the vehicle 10, the information management server 21 will judge as “Yes”, and will progress to Step S73. On the other hand, if a preference is not contained in the preference information of the user of the own vehicle 10 at all, the information management server 21 will judge as “No”, and will progress to Step S74.

In Step S73, the information management server 21 acquires the advertisement information corresponding to the preference of the user of the vehicle 10 (advertisement deliverer) and the preference of the user of the information terminal device 40 (advertisement receiver), and transmits this acquired advertisement information to the vehicle 10. In a concrete explanation, a situation where the user of the vehicle 10 has registered the fact that he or she is interested, for example, in accessories for a smart phone which he or she possesses as a matter of his (or her) current concern and/or interest which is a preference contained in preference information, and the user of the information terminal device 40 (advertisement receiver) who is not in a specific relation with the user of the vehicle 10 (advertisement deliverer) has registered the fact that that he or she is considering to purchase, for example, a smart phone as a matter of his (or her) current concern and/or interest which is a preference contained in preference information, is assumed.

In this case, as keywords corresponding to the preference of the user of the vehicle 10 (advertisement deliverer) and the preference of the user of the information terminal device 40 (advertisement receiver), the information management server 21 extracts a “smart phone” which the user possesses and an “accessory” used for this smart phone, and searches the advertisement information database 23d to acquire advertisement information relevant to the “smart phone” and “accessory”. And the information management server 21 transmits image data expressing the acquired advertisement information relevant to the “smart phone” and “accessory” to the vehicle 10 through the communication unit 22. After transmitting the image data expressing the advertisement information relevant to the “smart phone” and “accessory”, the information management server 21 progresses to Step S76 to once end the “advertisement delivery routine corresponding to a preference”, and returns to Step S59 of the “information delivery program.” And the information management server 21 progresses to Step S60 in the “information delivery program” to end execution of the information delivery program, and starts execution of the program again at Step S50 after progress of short predetermined time.

In the vehicle 10, the electronic control unit 12 receives and acquires the image data expressing the advertisement information relevant to the “smart phone” and “accessory” transmitted by the information management server 21 of the information management center 20 through the communication unit 13, and once memorizes the acquired image data in the predetermined memory site of the memory unit 14. And the electronic control unit 12 supplies the image data memorized in the predetermined memory site of the memory unit 14 to the body display part 11 through a drive circuit. Thereby, the body display part 11 displays advertisement of the “smart phone” which the user of the vehicle 10 (advertisement deliverer) possesses and the “accessory” used for this smart phone. Therefore, the electronic control unit 12 of the vehicle 10 can display advertisement which the user of the vehicle 10 (advertisement deliverer) wants to offer to the user of the information terminal device 40 (advertisement receiver) (information about the “accessory” for the “smart phone” which the user himself (or herself) possesses) and, for the user (advertisement receiver) of the information terminal device 40, advertisement (of concern) relevant to himself (or herself) (information about a “smart phone”) can be provided (displayed) through the vehicle 10.

On the other hand, in Step S74, the information management server 21 acquires the advertisement information corresponding to the preference of the user of the information terminal device 40 (advertisement receiver), and transmits this acquired advertisement information to the vehicle 10. In a concrete explanation, for example, a situation where the user of the information terminal device 40 (advertisement receiver) not in a specific relation with the user of the vehicle 10 (advertisement deliverer) has registered that he or she considers to purchase a smart phone as a matter of current concern and/or interest which is a preference contained in preference information is supposed. Therefore, in this case, as a keyword corresponding to the preference of the user of the information terminal device 40 (advertisement receiver), the information management server 21 extracts a “smart phone”, searches the advertisement information database 23d to acquire the advertisement information relevant to this “smart phone”. Thereby, the information management server 21 transmits image data expressing the advertisement information relevant to the acquired “smart phone” to the vehicle 10 through the communication unit 22, progresses to Step S76 to once end the “advertisement delivery routine corresponding to a preference”, and returns to Step S59 of the “information delivery program.” And the information management server 21 progresses to Step S60 in the “information delivery program” to end execution of the information delivery program, and starts execution of the program again at Step S50 after progress of short predetermined time.

In the vehicle 10, the electronic control unit 12 receives and acquires the image data expressing the advertisement information relevant to a “smart phone” transmitted by the information management server 21 of the information management center 20 though the communication unit 13, and once memorizes the acquired image data in the predetermined memory site of the memory unit 14. And the electronic control unit 12 supplies the image data memorized in the predetermined memory site of the memory unit 14 to the body display part 11 through a drive circuit. Thereby, the body display part 11 displays an advertisement relevant to a “smart phone” which smart phone makers and careers manufacture and/or sell. Therefore, the electronic control unit 12 of the vehicle 10 can offer (display) an advertisement relevant to (or of concern for) the user of the information terminal device 40 (advertisement receiver) (information about a “smart phone”) through the vehicle 10.

Moreover, in accordance with the “No” judging in the above-mentioned Step S71, the information management server 21 performs Step S75. In this situation where the Step S75 is performed, at least the preference of the user of the information terminal device 40 (advertisement receiver) has not been registered. For this reason, for displaying advertisement information on the body display part 11 of the vehicle 10, the information management server 21 acquires the advertisement information, for example, based on an advertisement display setting beforehand set up in order to display advertisement information with no regard to kinds and makers of goods, etc. Namely, the information management server 21 searches the advertisement information database 23d with a free keyword, and acquires advertisement information, for example. And the information management server 21 transmits the image data expressing the acquired miscellaneous advertisement information to the vehicle 10 through the communication unit 22. In the vehicle 10, the electronic control unit 12 receives and acquires the image data expressing the advertisement information transmitted by the information management server 21 of the information management center 20 through the communication unit 13, and once memorizes the acquired image data in the predetermined memory site of the memory unit 14. And the electronic control unit 12 supplies the image data memorized in the predetermined memory site of the memory unit 14 to the body display part 11 through a drive circuit. Thereby, the body display part 11 displays the miscellaneous advertisement with no regard to kinds and makers of goods.

And the information management server 21 progresses to Step S76 to once end the “advertisement delivery routine corresponding to a preference”, and returns to Step S59 of the “information delivery program.” And the information management server 21 progresses to Step S60 in the “information delivery program” to end execution of the information delivery program, and starts execution of the program again at Step S50 after progress of short predetermined time.

As can be understood from the above explanation, in accordance with the above-mentioned modification, information (including an advertisement) corresponding to the specific relation (relationship) between the user of the vehicles 10 (advertisement deliverer) who displays (delivers) the advertisement (including information) delivered from the information management center 20 and the user of the information terminal device 40 (advertisement receiver) who views the advertisement (including information) displayed (delivered) on the body display part 11 of the vehicle 10 can be automatically delivered to be displayed (delivered). Thereby, at least the advertisement (contents) which is information of the interest of the user of the information terminal device 40 (advertisement receiver) can be appropriately and automatically delivered and displayed.

In the above-mentioned modification, the information relevant to (or, of concern and/or interest for) the user of the information terminal device 40 (advertisement receiver) is displayed on the body display part 11 of the vehicle 10. In this case, since the body display part 11 of the vehicle 10 displays information towards the outside of a vehicle, general public may view the information displayed on the body display part 11 depending on a situation. For this reason, it is also possible to offer information to the user of the information terminal device 40 (advertisement receiver) who is a viewer in the surroundings of the vehicle 10.

Specifically, for example, using Bluetooth (registered trademark) and/or Wi-Fi (registered trademark) by the communication unit 13 and/or the short-distance wireless communications by NFC, the electronic control unit 12 of the vehicle 10 can establish communication between the information terminal devices 40, as mentioned above. Therefore, using such a communication, the electronic control unit 12 of the vehicle 10 transmits image data, such as a message, an image and an advertisement, etc. transmitted by the information management server 21 of the information management center 20 as mentioned above, to the information terminal device 40 using the communication unit 13, without displaying it on the body display part 11.

Thereby, the limited user who possesses the information terminal device 40 (advertisement deliverer) that can communicate with the vehicle 10 can view a message, an image and an advertisement displayed on the display unit 42 of the information terminal device 40, for example. Moreover, the user of the limited information terminal device 40 (advertisement receiver) on other vehicle 10 that can communicate with the vehicle 10 can view a message, an image and an advertisement displayed on the display disposed in the vehicle interior, for example. Namely, a situation where general public can view the information can be avoided by choosing (limiting) the target, to which the information is offered, such as the information terminal device 40 and other vehicle 10. As a result, the privacy of the user of the vehicle 10 (advertisement deliverer) and the user of the information terminal device 40 (advertisement receiver) can be protected appropriately.

Moreover, in the above-mentioned modification, by acquiring the unique identification information transmitted from the vehicle 10, the information management server 21 of the information management center 20 judges the relationship between the user of the vehicle 10 (advertisement deliverer) and the user of the information terminal device 40 (advertisement receiver), etc., and transmits the suitable information in accordance with this judged relationship to the vehicle 10. In this case, it is also possible to carry out the above-mentioned judgment by the information management center 20, etc. on the vehicle 10 side. In this case, by searching a database formed in the vehicle 10 so that it might be equivalent to the above-mentioned user information database 23a, or by acquiring the unique identification information, the preference information and the relationship information from the exterior, the electronic control unit 12 of the vehicle 10 can determine a user of the information terminal device 40 (advertisement receiver) in a specific relation with the user of the vehicle 10 (advertisement deliverer), as well as a user of the information terminal device 40 (advertisement receiver) not in the specific relation, to display suitable information (advertisement) corresponding to each user on the body display part 11, similarly to the above-mentioned modification.

By the way, when judging the relationship etc. on the vehicle 10 side, the electronic control unit 12 will acquire unique identification information, preference information, relationship information, etc. about a user of the information terminal device 40 (advertisement receiver) not in a specific relation in particular. In this case, from a viewpoint of privacy protection, it is preferable to avoid to acquire unique identification information, preference information, relationship information, etc. about a user of the information terminal device 40 (advertisement receiver) not in a specific relation as far as possible. For this reason, for example, when the above-mentioned “advertisement delivery routine corresponding to a preference” is performed to display advertisement information on the body display part 11, namely, when the user of the information terminal device 40 (advertisement receiver) not in a specific relation with the user of the self-vehicle 10 (advertisement deliverer) is provided with advertisement information, as mentioned above, using as an origination (trigger) the fact that the unique identification information of the information terminal device 40 was acquired by the passing-each-other communication with the vehicle 10, image data expressing the advertisement information corresponding to the preference of the user of the information terminal device 40 (advertisement receiver) specified based on the unique identification information of the information terminal device 40 acquired by the information management center 20 side may be transmitted. Thus, by determining advertisement information based on the judgment on the side of the information management center 20 regarding the user of the information terminal device 40 (advertisement receiver) not in a specific relation, it is not necessary to acquire unnecessary personal information on the vehicle 10 side, privacy and security can be secured successfully, and the same effect as the above-mentioned modification can be expected.

c-2. Case where an Advertisement is Displayed (Delivered) in Accordance with a Display Embodiment which Raises the Display Density of the Advertisement

As mentioned above, a technique for presenting an advertisement of the same business operator intensively (dominantly) in a specific area or specific space may be adopted for the purpose of raising the display density of the advertisement to raise advertising effectiveness, i.e., a propaganda effect. For this reason, a case where a specific advertisement (information) is delivered (displayed) through the body display part 11 of plural vehicles 10 will be explained.

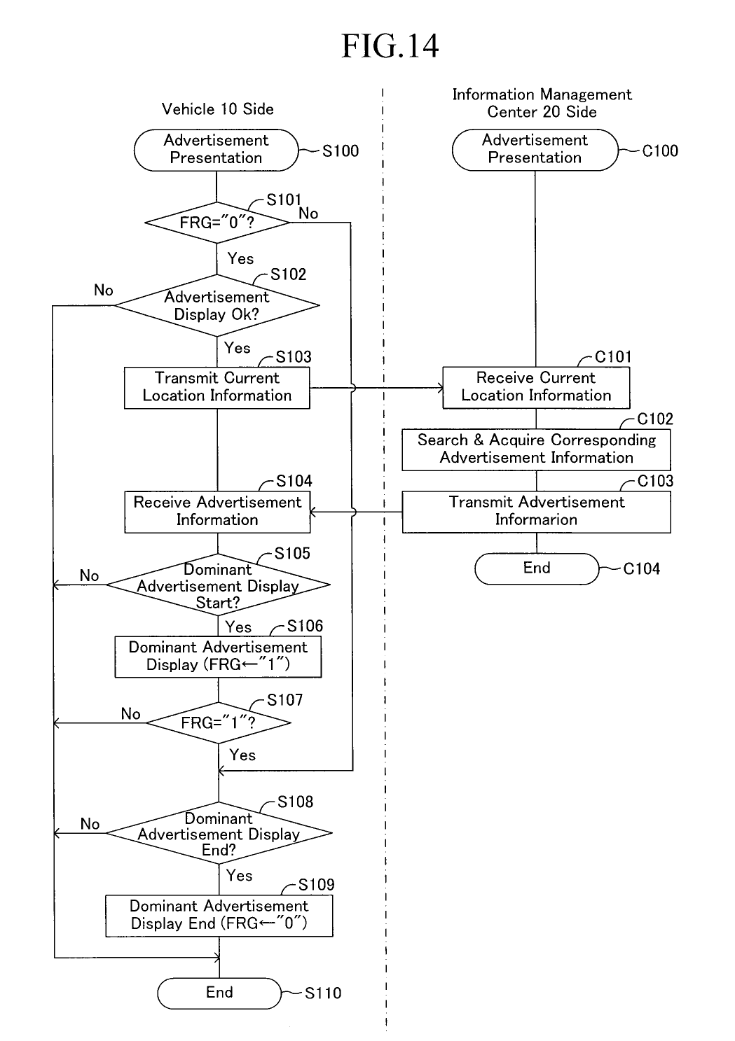

In this case, the electronic control unit 12 of each vehicle 10 starts execution of the advertisement presentation program on the vehicle 10 side shown in FIG. 14 at Step S100 with a short predetermined time interval. On the other hand, the information management server 21 of the information management center 20 starts execution of the advertisement presentation program on the information management center 20 side shown in FIG. 14 at Step C100 with a short predetermined time interval.

In each vehicle 10, in Step S101, the electronic control unit 12 judges whether the value of the display judging flag FRG which expresses whether a dominant advertisement display, which will be mentioned later, has been performed or not is set as “0” which means that the dominant advertisement display has not been performed. Namely, if the value of the display judging flag FRG is set as “0”, the electronic control unit 12 will judge as “Yes” and progress to Step S102. On the other hand, If the value of the display judging flag FRG is set as “1” which means that the dominant advertisement display has been performed, the electronic control unit 12 will judge as “No”, and progress to Step S108, and perform end judging processing of the dominant advertisement display.

In Step S102, the electronic control unit 12 judges whether the user of the vehicle 10 (advertisement deliverer) permits to display an advertisement using the body display part 11 mounted thereon or not. Namely, if it is set that the user of the vehicle 10 (advertisement deliverer) permits to display an advertisement, the electronic control unit 12 will judge as “Yes” at Step S102 and progress to Step S103. On the other hand, if it is set that the user of the vehicle 10 (advertisement deliverer) does not permit to display an advertisement, the electronic control unit 12 will judge as “No” and progress to Step S110, and will end execution of an advertisement presentation program. In addition, in this case, since the advertisement display is not permitted by the user of the vehicle 10 (advertisement deliverer), the electronic control unit 12 ends further execution of advertisement presentation programs.

In Step S103, since the advertisement display is currently permitted by the user of the vehicle 10 (advertisement deliverer) in accordance with the judgment processing in the above-mentioned Step S102, the electronic control unit 12 transmits the current location information of the vehicle 10 to the information management center 20. Namely, the electronic control unit 12 acquires the current location of the vehicle 10 detected by the location detection unit 15. And the electronic control unit 12 transmits the unique identification information of the vehicle 10 to the information management center 20 along with the current location information expressing the acquired current location using the communication unit 13.

In the information management center 20, the information management server 21 has started execution of the advertisement presentation program on the information management center 20 side at Step C100, and receives the current location information and unique identification information of the vehicle 10 which were transmitted at Step S103 in the advertisement presentation program on the above-mentioned vehicle 10 side through the communication unit 22 as vehicle information at Step C101. And the information management server 21 relates mutually the current location information and unique identification information which were received and acquired, memorizes them temporarily, for example, in the predetermined memory site of the memory unit 23, and progresses to Step C102.

In Step C102, the information management server 21 searches the advertisement information database 23b using the current location of the vehicle 10 expressed by the current location information temporarily memorized at the above-mentioned Step C101, and extracts and acquires advertisement information including an area reachable from this current location. And the information management server 21 progresses to Step C103 after acquiring corresponding advertisement information. In addition, in this search, when advertisement information including an area reachable from the current location does not exist, the information management server 21 acquires the reporting information expressing corresponding advertisement information does not exist.

In Step C103, the information management server 21 transmits the advertisement information or reporting information acquired at the above-mentioned step C102 through the communication unit 22 to the vehicle 10 using the unique identification information which was acquired at the above-mentioned step C101. And the information management server 21 progresses to Step C104, and once ends execution of the advertisement presentation program, and starts the execution again at Step C100 after progress of short predetermined time.

In the vehicle 10, the electronic control unit 12 receives the advertisement information or reporting information transmitted at Step C103 in the advertisement presentation program on the above-mentioned information management center 20 side, at Step S104 in the advertisement presentation program on the vehicle 10 side through the communication unit 13. And the electronic control unit 12 memorizes the received and acquired advertisement information or reporting information in the predetermined memory site of the memory unit 14 searchably, and progresses to Step S105. In addition, when the reporting information is acquired from the management server 21 of the information management center 20, since corresponding advertisement information does not exist within an area which the vehicle 10 can reach, the electronic control unit 12 can report to a user that the advertisement which should be displayed from the display or speaker disposed in the vehicle interior does not exist, for example.

In Step S105, the electronic control unit 12 judges whether a dominant advertisement display is started or not, based on the advertisement information acquired at the above-mentioned step S104. Hereafter, this judgment will be explained concretely.

The electronic control unit 12 compares the current location of the vehicle 10 detected by the location detection unit 15 with a specific area in which the advertisement included in the advertisement information acquired at the above-mentioned step S104 should be displayed, and judges whether the current location of the vehicle 10 exists within the specific area where the advertisement should be displayed. Moreover, the electronic control unit 12 judges whether the present time is in the time zone when the advertisement should be displayed, based on the time zone when the advertisement included in the advertisement information acquired at the above-mentioned step S104 should be displayed. And if the current location of the vehicle 10 exists within the specific area where the advertisement should be displayed and the present time is in the time zone when the advertisement should be displayed, in order to dominantly display the advertisement based on the advertisement information, the electronic control unit 12 will judge as “Yes” and progress to Step S106. On the other hand, if the current location of the vehicle 10 does not exist within the specific area where the advertisement should be displayed, or if the present time is not in the time zone when the advertisement should be displayed, since it is not necessary to dominantly display the advertisement yet, the electronic control unit 12 will judge as “No” and progress to Step S110, and once end execution of the advertisement presentation program. And it will start execution of the program again at Step S100 after progress of short predetermined time.

In Step S106, based on the advertisement information acquired at the above-mentioned step S104, the electronic control unit 12 cooperates with other vehicle 10 in the specific area where the advertisement should be displayed to occupy (jack) the display of a specific advertisement. Hereafter, this dominant display of an advertisement will be explained.

In all the vehicles 10 which acquired the same advertisement information as the advertisement information acquired at the above-mentioned Step S104, If they exist within the specific area where the advertisement should be displayed and the present time is in the time zone when the advertisement should be displayed, all the corresponding vehicles 10 will display the advertisement on each body display part 11 in accordance with a designated display embodiment. In this case, the corresponding vehicles 10 may be scattered over the specific area where the advertisement should be displayed, or they may be gathered in one place, such as a parking lot, by these vehicle 10 cooperating to display an advertisement in accordance with a predetermined display embodiment, the display density of the advertisement in a specific area can be increased, and the advertising effectiveness can be heightened dramatically.

Here, a display embodiment specified by advertisement information in order to heighten advertising effectiveness will be explained concretely. Fundamentally, the display embodiment specified in the advertisement information which each vehicle 10 acquires is a “cooperative display” wherein plural vehicles 10, more particularly plural body display parts 11, display a predetermined advertisement in conjunction with one another, and this “cooperative display” further includes “business operator cooperation” and “audience cooperation”. Moreover, as one embodiment of the “cooperative display”, there is a “synchronous display”, and this “synchronous display” includes a “still image display”.

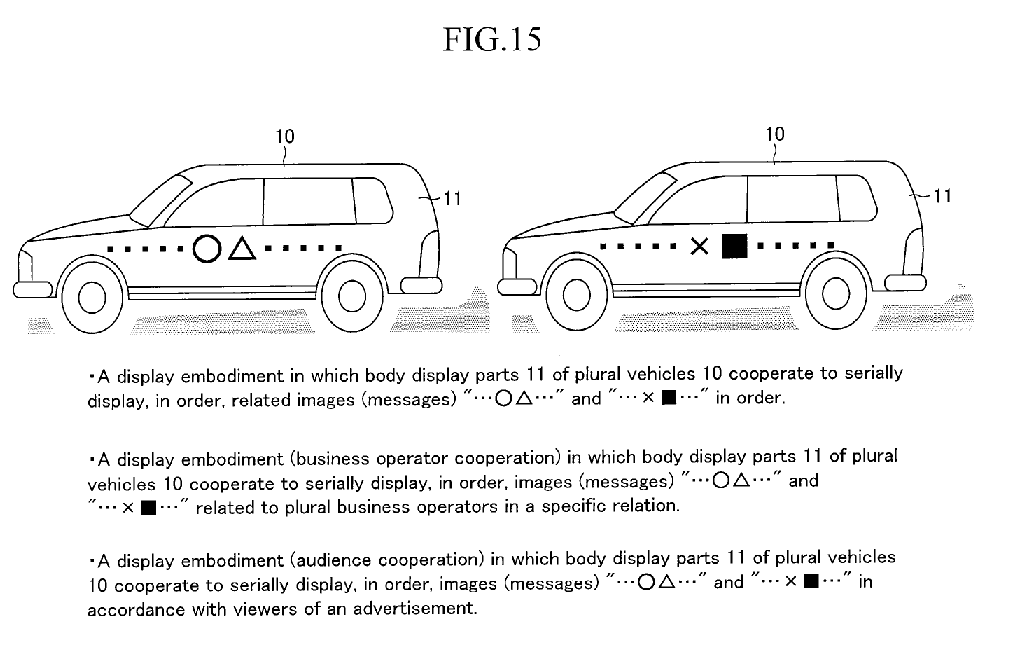

The “cooperative display” is a display embodiment in which, for example, in respective vehicles 10 which exist in a specific area where an advertisement should be displayed, respective body display parts 11 cooperate to display an identical or plural images (pictures) and/or messages in order or synchronously, or to display an identical image (picture) with background color changed, as schematically shown in FIG. 15. And as an example of cooperation of respective body display parts 11 for displaying an image (picture) and/or a message, there are “business operator cooperation” wherein body display parts 11 of plural vehicles 10 cooperate mutually to display an image (picture) related to plural business operators in a specific relation (what is called, a relation of collaboration, etc.) in order in accordance with the relation among these business operators, and “audience cooperation” wherein body display parts 11 of plural vehicles 10 cooperate mutually to display an image (picture) in order in accordance with genders and/or ages, etc. of the user of the information terminal device 40 (advertisement receiver) who is an audience (viewer). By designating such a “cooperative display” as a display embodiment, respective body display parts 11 of plural vehicles 10 which exist in a specific area display an image (picture) and/or a message in order in conjunction with one another, and therefore advertising effectiveness to the user of the information terminal device 40 (advertisement receiver) who looked at this image (picture) and/or message, i.e., an advertisement can be heightened.

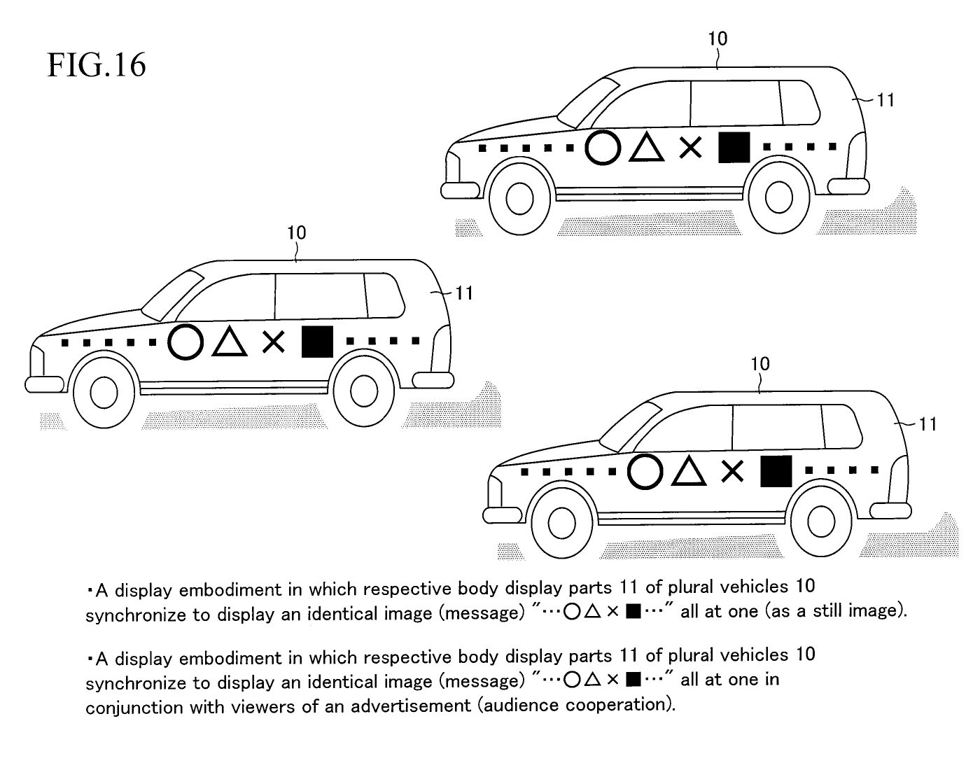

Moreover, as schematically shown in FIG. 16, the “synchronous display” as one embodiment of the “cooperative display” is a display embodiment in which, for example, in respective vehicles 10 which exist in a specific area where an advertisement should be displayed, respective body display parts 11 synchronously display an identical image (picture) and/or a message all at once, or respective body display parts 11 synchronously display an identical image (picture) and/or a message all at once in accordance with genders and/or ages, etc. of the user of the information terminal device 40 (advertisement receiver) who is an audience (viewer) (in conjunction with audience). And as an example of an embodiment in which respective body display parts 11 synchronously display an image (picture) and/or a message, there is a “still image display” in which respective vehicles 10 which exist in a specific area where an advertisement should be displayed continue displaying an identical still image on their respective body display parts 11 in a time zone when an advertisement should be displayed. By designating such a “synchronous display” as a display embodiment, all the body display parts 11 of plural vehicles 10 which exist in a specific area display a synchronized image (picture) and/or message all at once, and therefore a strong impression can be given to the user of the information terminal device 40 (advertisement receiver) who looked at this image (picture) and/or message, i.e., an advertisement, to heighten a propaganda effect.

Therefore, the electronic control unit 12 controls the display by the body display part 11 at Step S106 based on the advertisement information acquired at the above-mentioned Step S104. Concretely, the electronic control unit 12 supplies the picture (image) data contained in the acquired advertisement information to the body display part 11 through a drive circuit. Moreover, the electronic control unit 12 checks the display embodiment contained in the advertisement information and, for example, when the “synchronous display” is designated, it matches advertising contents to be displayed and display timing by communicating with the electronic control units 12 of other vehicles 10 mutually using the communication unit 13, and synchronously displays image (picture) data, i.e., an advertisement, on the body display part 11. Alternatively, the electronic control unit 12 checks the display embodiment contained in the advertisement information and, for example, when the “cooperative display” is designated, it matches display order by communicating with the electronic control unit 12 of other vehicle 10 mutually using the communication unit 13, and displays image (picture) data, i.e., an advertisement, in conjunction with other body display part 11 (for example, scrolling it). Thus, by communication between vehicles 10, an advertisement can be displayed more appropriately and correctly, cooperatively or synchronously.

After dominantly displaying the advertisement in a specific area in accordance with advertisement information, the electronic control unit 12 sets the value of the display judging flag FRG into “1” expressing that the advertisement has been dominantly displayed, in place of “0”. And the electronic control unit 12 progresses to Step S107.

In Step S107, the electronic control unit 12 judges whether the display judging flag FRG is “1” or not. Namely, if the dominant advertisement display has been completed and the value of the display judging flag FRG has been set as “1” at the above-mentioned step S106, since the dominant display of advertisement still continues, the electronic control unit 12 will judge as “Yes” and progress to Step S108. On the other hand, for example, if cooperation with other vehicle 10 (more particularly, other electronic control units 12) is still in the process of adjustment and the value of the display judging flag FRG cannot yet be changed into “1”, the electronic control unit 12 will judge as “No” and progress to Step S110, and once end execution of the advertisement presentation program. And it will start execution of the program again at Step S100 after progress of short predetermined time.

In Step S108, the electronic control unit 12 judges whether the dominant advertisement display should be ended or not, based on the advertisement information acquired at the above-mentioned Step S104. Namely, the electronic control unit 12 compares the current location of the vehicle 10 detected by the location detection unit 15 with the specific area where the advertisement should be displayed included in the advertisement information acquired at the above-mentioned Step S104, and judges whether the current location of the vehicle 10 exists within the specific area where the advertisement should be displayed. Moreover, the electronic control unit 12 judges whether the present time is in the time zone when the advertisement should be displayed or not, based on the time zone when the advertisement should be displayed contained in the advertisement information acquired at the above-mentioned Step S104.

And if the current location of the vehicle 10 does not exist within the specific area where displays an advertisement or if the present time is not in the time zone when the advertisement should be displayed, since it is not necessary to dominantly display the advertisement based on advertisement information, the electronic control unit 12 will judge as “Yes” and progress to Step S109. On the other hand, if the current location of the vehicle 10 still exists within the specific area where the advertisement should be displayed and the present time is still in the time zone when the advertisement should be displayed, in order to continue the dominant display of the advertisement, the electronic control unit 12 will judge as “No” and progress to Step S110, and once end execution of the advertisement presentation program. And execution of the program is again started at Step S100 after progress of short predetermined time.

In Step S109, the electronic control unit 12 stops the display of the image (picture) and/or message by the body display part 11 through a drive circuit, in accordance with “No” judging processing in the above-mentioned Step S108. And the electronic control unit 12 progresses to Step S110, and once ends execution of the advertisement presentation program, and starts execution of the program again at Step S100 after progress of short predetermined time.

As can be understood also from the above explanation, in accordance with the above-mentioned modification, the information management center 20 can transmit advertisement information to plural vehicles 10 which can reach the specific area where the advertisement should be displayed and can exist within the specific area, based on the current location information transmitted from the vehicles 10. And when plural vehicles 10 which acquired identical advertisement information exist within the specific domain, based on the same advertisement information, respective body display parts 11 of plural vehicles 10 can display the advertisement (or information) outward from the vehicles 10 in accordance with the cooperative display or synchronous display. Thereby, for example, plural vehicles 10 within the specific area, more particularly, the body display parts 11 disposed in plural vehicle 10, intensively (dominantly) displays the advertisement of a specific business operator or collaborating business operator and thereby advertising density can be raised effectively and, as a result, an opportunity for the user of the information terminal device 40 (advertisement receiver) to see the advertisement can be increased, and/or a strong impression can be given to the user to raise advertising effectiveness (propaganda effect) dramatically.

In the above-mentioned modification, the information management center 20 transmits (delivers) corresponding advertisement information to each vehicle 10 which can reach the specific area where the advertisement should be displayed based on advertisement information. In this case, it is also possible to transmit the advertisement information of the store 30 to all the vehicles 10 which exist within the transmitting area to which a variety of information can be transmitted from the store 30 which has a transmitting function (advertisement information transmitting means) of the advertisement information in the information management center 20 at least and wishes an advertisement display. Also in this case, the electronic control unit 12 of the vehicle 10 located within the transmitting area equivalent to the specific area where the advertisement should be displayed can cooperate with the body display part 11 of other vehicle 10 in the transmitting area to display an advertisement (or information) on the own body display part 11 in accordance with a predetermined display embodiment and can dominantly display the advertisement, based on the acquired advertisement information, similarly to the above-mentioned modification. Therefore, while the same effect as the above-mentioned modification can be expected, it is not necessary to judge whether the vehicle 10 exists in a transmitting area or not, and the advertising effectiveness of the store 30 can be heightened easily.

In implementation of the present invention, it is not limited to each above-mentioned embodiment and each modification and various change is possible unless it deviates from the purpose of the present invention.

For example, in each embodiment and each modification mentioned above, a reward point is given to the user of the vehicle 10 who is an advertisement deliverer and the user of the information terminal device 40 which is an advertisement receiver. In this case, as for the given reward point, it is possible to set up the time limit and/or use restrictions, for example, so that it can use only within a predetermined period. Moreover, it is also possible to provide, for example, coupon which can be used only within a predetermined period or can be used for purchasing only restricted goods in place of a reward point. By thus setting up the time limit and/or use restrictions, use of a reward point (coupon) can be prompted effectively.

Moreover, in the above-mentioned second embodiment, a reward point is given to both of the user of the vehicle 10 who is an advertisement deliverer and the user of the information terminal device 40 who is an advertisement receiver. In this case, it is needless to say that a reward point corresponding to the results information about the sales results of a advertised good may be given only to the user of the vehicle 10 who has cooperated in an advertisement display.

Moreover, in the above-mentioned second embodiment, searching is always carried out so that the electronic control unit 12 of the vehicle 10 and the electronic control unit 41 of the information terminal device 40 could always perform a pass-each-other communication. Moreover, when the user of the information terminal device 40 purchases an advertised good, the purchase history information about the purchase of this advertised good is automatically transmitted to the information management server 21 of the information management center 20. In this case, according to the intention of the user of the information terminal device 40, it is possible to set the propriety of passing-each-other communication and/or the transmitting propriety of purchase history information, namely, it is possible to permit or forbid acquisition of the track record of short-distance wireless communications. Thereby, since the user of the information terminal device 40 can permit short-distance wireless communications only when there is an intention of liking to receive service like grant of a reward point, for example, the privacy and security of the user of the information terminal device 40 can be secured successfully.

Moreover, in the above-mentioned second embodiment, the advertisement information and purchase history information acquired by passing-each-other delivery is accumulated and memorized in the predetermined memory site of the memory unit 44 of the information terminal device 40. In this case, in order to use a resource effectively while reducing the load to the information terminal device 40, for example, it is possible to eliminate old advertisement information and old (past) purchase history information automatically one by one and/or with manual operation by the user himself (or herself) of the information terminal device 40. Thereby, unnecessary information can be eliminated appropriately and a resource can be secured sufficiently.

Moreover, in the above-mentioned second embodiment, the advertisement information acquired by passing-each-other delivery is accumulated and memorized in the predetermined memory site of the memory unit 44 in the information terminal device 40. And, for example, when the user of the information terminal device 40 communicates with the electronic control unit 31 of the store 30 by a short-distance wireless communication using the communication unit 43 of the equipment 40 and purchases an advertised good, a predetermined reward point is given.

In this case, for example, in a case where the information terminal device 40 acquired advertisement information from the vehicle 10 by pass-each-other delivery, the acquired advertisement information is temporarily saved securely on the network along with the unique identification information of the vehicle 10 and the information terminal device 40 and, for example, even when purchasing an advertised good without using the information terminal device 40, for example, when purchasing an advertised good by a computer at home using the Internet, etc., it is also possible to appropriately give a predetermined reward point. In this case, by acquiring the advertisement information saved securely on the network and the unique identification information of the vehicle 10 and the information terminal device 40 when purchasing an advertised good using the Internet, purchase history information can be acquired similarly to the above-mentioned second embodiment. And the information management server 21 can give a predetermined reward point to the users of the vehicle 10 and the information terminal device 40 similarly to the above-mentioned second embodiment by transmitting the acquired purchase history information to the information management center 20. Moreover, in this case, since an advertised good can be purchased using a reward point, without using the information terminal device 40, it becomes possible to adopt an in-vehicle information terminal device carried in a vehicle as the information terminal device 40, for example.

Moreover, in each above-mentioned embodiment and each modification, the body display part 11 consisting of a well-known sheet-like light-emitting type display panel or transmitted light type display panel, etc. is disposed (stuck) as a display part on an outside surface of the shell of the vehicle 10. In this case, it is needless to say that any kind of thing can be adopted for constituting the body display part 11 as long as it can present an advertisement for advertisement audience located outward from the vehicle 10. As such a body display part 11, for example, what is called display device with a housing which consists of a well-known light-emitting type display panel (for example, a plasma display panel, an organic electroluminescence display panel, etc.) or transmitted light type display panel (for example, a liquid-crystal-display panel with a back light, etc.) can be employed.

Moreover, in each above-mentioned embodiment and each modification, a predetermined advertisement is displayed using the body display part 11 of the vehicle 10 which can move. In this case, it is needless to say that a predetermined advertisement may be displayed, for example, using a display device fixed to the wall of a building, etc., what is called digital signage, as a display part which is a medium for displaying an advertisement. Also in this case, since a predetermined advertisement can be displayed appropriately, the same effect as each above-mentioned embodiment and each modification can be expected.

Furthermore, it is also possible to carry out the combination of the above-mentioned first embodiment and the above-mentioned second embodiment. Since the effect by the first embodiment mentioned above and the effect by the second embodiment can be acquired when carrying out the combination of the above-mentioned first and the second embodiment, it is more suitable.

1-20. (canceled)

21. An advertisement presentation system comprising an advertisement presentation means to acquire advertisement information expressing an advertisement and to display and present a predetermined advertisement to general public based on this acquired advertisement information, and an advertisement information provision means to provide said advertisement information to this advertisement presentation means, comprising:
a results information acquisition means to acquire results information about a change of the sales results of an advertised good which is an object of said predetermined advertisement, which changes due to presentation of said predetermined advertisement by said advertisement presentation means,
a remuneration determination means to determine remuneration to be paid to presentation of said predetermined advertisement by said advertisement presentation means, based on said acquired results information, and
a location information acquisition means to acquire location information expressing location of said advertisement presentation means,
said results information acquisition means acquires said results information about a change of the sales results of said advertised good within a predetermined distance from the location of said advertisement presentation means expressed by said acquired location information.

22. The advertisement presentation system according to claim 21, wherein:
said results information acquisition means acquires said results information about a change of sales results of said advertised good within a predetermined time period after said advertisement presentation means ends presentation of said predetermined advertisement.

23. The advertisement presentation system according to claim 21, wherein:
said remuneration determination means determines remuneration according to an increase relevant to sales volume of said advertised good based on said acquired results information, when the increase relevant to the sales volume of said advertised good among changes of the sales results of said advertised good is larger than a predetermined increase set up beforehand.

24. The advertisement presentation system according to claim 21, wherein:
said advertisement presentation means is configured so as to afford a short-distance wireless communication with at least an information terminal device which exists in surroundings, and
said results information acquisition means comprises;
a communication results information acquisition means to acquire communication results information about track record of a short-distance wireless communication between said advertisement presentation means and said information terminal device, and
an advertised good purchase information acquisition means to acquire advertised good purchase information about purchase of said advertised good by a user of said information terminal device related with said acquired communication results information, and
said results information acquisition means acquires said results information about a change of the sales results of said advertised good based on said acquired advertised good purchase information.

25. The advertisement presentation system according to claim 24, wherein:
said information terminal device acquires said advertisement information from said advertisement presentation means through said short-distance wireless communication, and presents said predetermined advertisement based on said acquired advertisement information to said user.

26. The advertisement presentation system according to claim 24, wherein:
acquisition of said communication results information by said communication results information acquisition means is permitted or forbidden by the user of said information terminal device.

27. The advertisement presentation system according to claim 24, wherein:
said remuneration determination means determines the predetermined remuneration to be paid to the user of said information terminal device, at least when a track record of short-distance wireless communication between said advertisement presentation means and said information terminal device exists, based on said acquired communication results information.

28. The advertisement presentation system according to claim 27, wherein:
the remuneration information which expresses said predetermined remuneration determined by said remuneration determination means is transmitted to said information terminal device.

29. The advertisement presentation system according to claim 21, wherein:
said remuneration determination means determines said remuneration with a time limit or use restriction.

30. The advertisement presentation system according to claim 21, wherein:
said results information acquisition means can be connected with a network to acquire said results information from the store which sells said advertised good through the network.

31. An advertisement presentation device comprising a display part which displays an advertisement and a control part which controls the display of the advertisement by this display part, wherein:
said control part acquires advertisement information expressing an advertisement acquired from the outside, displays and presents a predetermined advertisement to general public based on this acquired advertisement information, and acquires remuneration to be paid to presentation of said predetermined advertisement, according to a change of sales results of an advertised good which is an object of said predetermined advertisement, acquires location information expressing location of said display part at least, and acquires remuneration to be paid to presentation of said predetermined advertisement, according to a change of the sales results of said advertised good within a predetermined distance from the location of said display part expressed by said acquired location information.

32. The advertisement presentation device according to claim 31, wherein:
said control part delivers said advertisement information acquired from said outside to an information terminal device which exists in the surroundings of said display part, through a short-distance wireless communication between said information terminal device, at least.

33. The advertisement presentation device according to claim 31, wherein:
said display part is disposed on an outside surface of an outer panel of a vehicle and displays a picture outward from said vehicle.

34. An advertisement provision device which provides the outside with advertisement information which expresses an advertisement, comprising:
a results information acquisition means to acquire results information about a change of sales results of an advertised good which is an object of an predetermined advertisement, which is changed by providing the outside with said advertisement information which expresses said predetermined advertisement, and
a remuneration determination means to determine remuneration to be paid to said outside, based on said acquired results information, and
a location information acquisition means to acquire location information expressing location of said outside to which advertisement information expressing said predetermined advertisement is provided, and
said results information acquisition means acquires said results information about a change of the sales results of said advertised good within a predetermined distance from the location of said outside expressed by said acquired location information.

35. The advertisement provision device according to claim 34, wherein:
said results information acquisition means acquires said results information about a change of the sales results of said advertised good within a predetermined time period after said advertisement information which expresses said predetermined advertisement is provided to said outside.

36. The advertisement provision device according to claim 34, wherein:
said results information acquisition means comprises;
a communication results information acquisition means to acquire communication results information about track record of a short-distance wireless communication between said outside and an information terminal device which exists in surroundings of said outside to which said advertisement information expressing said predetermined advertisement is provided, and
an advertised good purchase information acquisition means to acquire advertised good purchase information about purchase of said advertised good by a user of said information terminal device related with said acquired communication results information, and
said results information acquisition means acquires said results information about a change of the sales results of said advertised good based on said acquired advertised good purchase information.

37. The advertisement provision device according to claim 36, wherein:
acquisition of said communication results information by said communication results information acquisition means is permitted or forbidden by the user of said information terminal device.
